(19) United States
(12) Patent Application Publication
(10) Pub. No.: US 2026/0056107 A1
(43) Pub. Date: Feb. 26, 2026

(54) OPTICAL SYSTEMS AND PLATFORMS FOR SIMULTANEOUSLY ANALYZING MULTIPLE SOLUTION PROPERTIES

(71) Applicants: THE REGENTS OF THE UNIVERSITY OF CALIFORNIA, Oakland, CA (US); AMGEN INC., Thousand Oaks, CA (US)

(72) Inventors: Michelle Digman, Irvine, CA (US); Francesco Palomba, Irvine, CA (US); Lorenzo Scipioni, Irvine, CA (US); Sandeep Chhabra, Thousand Oaks, CA (US)

(21) Appl. No.: 19/105,299

(22) PCT Filed: Aug. 30, 2023
(86) PCT No.: PCT/US2023/031571

§ 371 Date: Feb. 20, 2025

Related U.S. Application Data
(60) Provisional application No. 63/402,462, filed on Aug. 30, 2022.

(51) Int. Cl. G01N 11/02; G01N 11/00

(52) U.S. Cl. CPC G01N 11/02; G01N 2011/008

(57) ABSTRACT

Disclosed herein are optical systems and platforms for the simultaneous assessment of one or more properties of a sample, e.g., a biomolecule-containing pharmaceutical composition, including, e.g., aggregation, phase separation, and/or viscosity, as well as methods of using the same.

### CROSS REFERENCE TO RELATED APPLICATIONS

This application claims the benefit of priority to U.S. Provisional Application Ser. No. 63/402,462, filed Aug. 30, 2022, the disclosure of which is incorporated herein by reference.

### STATEMENT OF GOVERNMENT SUPPORT

This invention was made with Government support under Grant No. 1841509, awarded by the National Science Foundation, and Grant No. 2P41GM103540, awarded by the National Institutes of Health. The Government has certain rights in the invention.

### TECHNICAL FIELD

The present disclosure provides optical systems and platforms, e.g., high-throughput optical systems and platforms, for the simultaneous assessment of multiple physicochemical properties, such as, e.g., aggregation, presence of phase separation, and/or viscosity, of a composition, such as, e.g., an aqueous composition or a pharmaceutical composition comprising one or more biomolecules. Also provided are methods of using the same, including, e.g., methods of using the same in drug screening.

### BACKGROUND

Methods for comprehensively characterizing the physical and/or chemical (i.e., physicochemical) properties of pharmaceutical compositions are critical for the development of novel therapeutics. Specifically, understanding multiple properties of a composition such as, e.g., viscosity, aggregation, pH, ionic strength, and/or the presence of phase separation, is fundamental to the formulation of stable biomolecule-based therapeutics. However, typical characterization methods require large sample volumes (e.g., 10's of microliters) and long analysis times (e.g., several minutes), resulting in precious material waste and low-throughput analysis. Accordingly, there is a need in the art for an optical platform and/or system for the assessment of multiple physicochemical properties, e.g., viscosity and aggregation, of a composition, including, e.g., a pharmaceutical composition, that utilizes smaller sample volumes and facilitates shorter analysis times.

### SUMMARY

The present disclosure provides a versatile optical system and/or platform, such as, e.g., a high-throughput optical system and/or platform, for the simultaneous assessment of viscosity and at least one additional physical and/or chemical property of a composition. Illustratively, the optical system and/or platform comprises a spectral/hyperspectral imaging device that can simultaneously assess environmentally sensitive fluorophore probe emission spectra and fluorescent tracker particle (nano- and micro-) dynamics. In some embodiments, the optical system and/or platform disclosed herein pairs the detection of aggregation or phase separation behavior with fluorescent tracker dynamics to simultaneously assess aggregation and viscosity. In some embodiments, the optical system and/or platform may be capable of analyzing a sample with a volume greater than or equal to 1 μL (such as, e.g., a volume greater than or equal to 2 μL; a volume in the range of 1 μL to 5 μL).

Some embodiments of the present disclosure provide an optical platform and/or system that is configured to simultaneously assess viscosity and at least one additional physical and/or chemical property (such as, e.g., aggregation or phase separation behavior of one or more agent(s) in a sample) of a sample, the optical platform and/or system comprising: a hyperspectral/spectral imaging device that is capable of simultaneously detecting and/or assessing one or more spectral properties of one or more environmentally sensitive fluorophore(s) and to track the dynamics of one or more fluorescent tracker particle(s), wherein:
tracking the dynamics of the one or more fluorescent tracker particle(s) can be used to assess the viscosity of the sample; and
detecting and/or assessing the one or more spectral properties of the one or more environmentally sensitive fluorophore(s) can be used to assess the at least one additional physical and/or chemical property of the sample.

In some embodiments, the optical platform and/or system is capable of simultaneously assessing multiple samples. In some embodiments, the optical platform and/or system is capable of simultaneously assessing 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, or a range that includes or is between any two of the foregoing numbers samples. In some embodiments, the optical platform and/or system is capable of simultaneously assessing 8, 12, 16, 24, 36, 48, or 96 samples. In some embodiments, the optical platform and/or system is a high-throughput optical platform and/or system.

In some embodiments, the at least one additional physical and/or chemical property of the sample is chosen from aggregation, phase separation behavior, pH, temperature, ionic potential, ionic strength, and kinetics over time. In some embodiments, the at least one additional physical and/or chemical property of the sample is aggregation. In some embodiments, the at least one additional physical and/or chemical property of the sample is phase separation behavior.

In some embodiments, the optical platform and/or system is capable of assessing viscosity and at least one additional physical and/or chemical property of a sample (such as, e.g., aggregation and/or phase separation behavior of one or more agent(s) in the sample) in less than 10 seconds (such as, e.g., less than 9 seconds, less than 8 seconds, less than 7 seconds, less than 6 seconds, less than 5 seconds; 2 seconds, 3 seconds, 4 seconds, 5 seconds, 6 seconds, 7 seconds, 8 seconds, 9 seconds).

In some embodiments, each sample assessed has a volume independently chosen from 0.2 μL, 0.3 μL, 0.4 μL, 0.5 μL, 0.6 μL, 0.7 μL, 0.8 μL, 0.9 μL, 1.0 μL, 1.1 μL, 1.2 μL, 1.3 μL., 1.4 μL, 1.5 μL, 1.6 μL, 1.7 μL, 1.8 μL, 1.9 μL, 2.0 μL, 2.1 μL, 2.2 μL., 2.3 μL, 2.4 μL, 2.5 μL, 2.6 μL, 2.7 μL, 2.8 μL, 2.9 μL, 3.0 μL, 3.1 μL, 3.2 μL, 3.3 μL, 3.4 μL, 3.5 μL, 3.6 μL, 3.7 μL, 3.8 μL, 3.9 μL, 4.0 μL, 4.1 μL, 4.2 μL, 4.3 μL, 4.4 μL, 4.5 μL, 4.6 μL, 4.7 μL, 4.8 μL., 4.9 μL, 5.0 μL, 5.2 μL, 5.4 μL, 5.6 μL, 5.8 μL, 6.0 μL, 6.2 μL, 6.4 μL, 6.6 μL, 6.8 μL, 7.0 μL, 7.2 μL, 7.4 μL, 7.6 μL, 7.8 μL, 8.0 μL, 8.2 μL, 8.4 μL, 8.6 μL, 8.8 μL, 9.0 μL, 9.2 μL, 9.4 μL, 9.6 μL, 9.8 μL, 10.0 μL, 10.5 μL, 11.0 μL, 11.5 μL, 12.0 μL, 12.5 μL, 30.0 μL, 13.5 μL, 14.0 μL, 14.5 μL, 15.0 μL, 15.5 μL, 16.0 μL, 16.5 μL, 17.0 μL, 17.5 μL, 18.0 μL, 18.5 μL, 19.0 μL, 19.5 μL, 20.0 μL, 25.0 μL, 30.0 μL, 35.0 μL, 40.0 μL, 45.0 μL, 50.0 μL, 60.0 μL, 70.0 μL, 80.0 μL, 80.0 μL, 100.0 μL, and a range that includes or is between any two of the foregoing volumes. In some embodiments, each sample assessed has a volume of 1.0 μL to 5.0 μL.

In some embodiments, each sample assessed comprises one or more agent(s) chosen from molecules, biomolecules, compounds, and polymers. In some embodiments, the one or more agent(s) are biomolecules chosen from proteins, peptides, lipids, saccharides, carbohydrates, nucleic acids, and steroids.

In some embodiments, the hyperspectral/spectral imaging device is a camera-based device. In some embodiments, the optical system and/or platform further comprises a wide field microscopy setup, a high and low illumination (HiLo) setup, or a structured illumination microscopy (SIM) setup. In some embodiments, the optical system and/or platform further comprises a wide field microscopy setup. In some embodiments, the optical system and/or platform further comprises a high and low illumination (HiLo) setup. In some embodiments, the optical system and/or platform further comprises a structured illumination microscopy (SIM) setup. In some embodiments, the hyperspectral/spectral imaging device utilizes a plurality of illumination and spatial resolution modalities. In some embodiments, the hyperspectral/spectral imaging device utilizes one or more (e.g., one, two, or three) illumination and spatial resolution modalities chosen from (i) wide field; (ii) high and low illumination (HiLo); and (iii) structured illumination (SIM).

In some embodiments, the hyperspectral/spectral imaging device performs multicolor detection. In some embodiments, the hyperspectral/spectral imaging device can assess 2, 3, or 4 different color components in a single pixel simultaneously.

In some embodiments, the hyperspectral/spectral imaging device achieves spectral/hyperspectral detection using a modality chosen from band-pass filters, band-pass camera masks, sin/cosine filters, and sin/cosine camera masking. In some embodiments, the hyperspectral/spectral imaging device achieves spectral/hyperspectral detection using one or more band-pass filter(s). In some embodiments, the hyperspectral/spectral imaging device achieves spectral/hyperspectral detection using one or more band-pass camera mask(s). In some embodiments, the hyperspectral/spectral imaging device achieves spectral/hyperspectral detection using one or more sin/cosine filter(s). In some embodiments, the hyperspectral/spectral imaging device achieves spectral/hyperspectral detection using sin/cosine camera masking.

In some embodiments, the hyperspectral/spectral imaging device utilizes a plurality of spectral and/or hyperspectral detection modalities that differ by efficiencies in terms of one or more properties chosen from quantum yield, spectral resolution, single pixel sensitivity, and portability. In some embodiments, the plurality of spectral and/or hyperspectral detection modalities comprise band-pass filters, band-pass camera masks, sin/cosine filters, and/or sin/cosine camera masking.

In some embodiments, the optical platform or system comprises one or more environmentally sensitive fluorophore probe(s) that can probe a physical and/or chemical property based on changes of fluorescence quantum yield and/or a change in the emission color. In some embodiments, the optical platform and/or system comprises one or more environmentally sensitive fluorophore probe(s) that can probe the presence of aggregates and/or phase separation by changes of fluorescence quantum yield and/or a change in the emission color. In some embodiments, at least one of the one or more environmentally sensitive fluorophore probe(s) is capable of providing nanometer scale sensitivity.

In some embodiments, at least one of the one or more environmentally sensitive fluorophore probe(s) is independently chosen from solvatochromic fluorophore-based probes. Examples of solvatochromic fluorophore-based probe(s) include, but are not limited to, propionyl-2-(dimethylaminonaphthalene) (PRODAN), 6-acetyl-2-dimethylaminonaphthalene (ACDAN), nitrobenz-2-oxa-1,3-diazol-4yl amine (NBD), coumarin derivatives, oxazine derivatives, 9-(diethylamino)-5H-benzo[a]phenoxazin-5-one (Nile Red), [9-(diethylamino)benzo[a]phenoxazin-5-ylidene]azanium sulfate (Nile Blue), dimethylamino-phthalimide/naphthalimides, merocyanines, Daproxyl® derivatives, and 1-(2-maleimidylethyl)-4-(5-(4-methoxyphenyl)oxazol-2-yl) pyridinium methanesulfonate) (PyMPO). In some embodiments, at least one of the one or more environmentally sensitive fluorophore probe(s) is independently chosen from ACDAN and Nile Red. In some embodiments, the solvatochromic fluorophore-based probe(s) is/are ACDAN. In some embodiments, the solvatochromic fluorophore-based probe(s) is/are Nile Red.

In some embodiments, the spectral/hyperspectral imaging device can detect changes in at least one of the one or more environmentally sensitive probe(s) caused by the presence of aggregates/phase separation by using spectral phasor analysis and/or generalized polarization analysis. In some embodiments, phasor analysis is used to segment regions of images that are related to different features, wherein the different features correspond to aggregates or phase separations. In some embodiments, the optical platform and/or system further comprises a plurality of fluorescently labeled tracker particles, wherein the tracker particle dynamics can be tracked using the spectral/hyperspectral imaging device. In some embodiments, the viscosity of a sample can be determined based upon tracker particle dynamics. In some embodiments, the viscosity of each sample assessed can be determined based upon tracker particle dynamics. In some embodiments, the plurality of fluorescently labeled tracker particles comprises particles of different sizes and/or surface properties that emit different color tracers. In some embodiments, fluorescence fluctuations of the plurality of fluorescently labeled tracker particles may be recorded over time using the spectral/hyperspectral imaging device and an autocorrelation function is measured to obtain the diffusion coefficient of the fluorescent particles that is inversely proportional to the viscosity of each sample assessed. In some embodiments, the spectral/hyperspectral imaging device is used to detect the position of each fluorescently labeled tracker particle over time, wherein the viscosity of each sample is assessed based upon changes and/or dynamics in the position of the fluorescently labeled tracker particles. In some embodiments, the dynamics of the plurality of fluorescently labeled tracker particles is mapped by imaging mean square displacement (iMSD) with a pixel averaged spatiotemporal correlation function which decays and spreads as function of the lag time, wherein the decays depend on the particle dynamics that is influenced by the viscosity of the sample.

In some embodiments, the hyperspectral/spectral imaging device comprises:
a light emitting device that emits a beam of light; one or more mirrors that direct the beam of light from the light emitting device to a light filter;
a light filter that filters the light emitted from the light emitting device to have a certain frequency so as to generate fluorescence signals from the one or more environmentally sensitive fluorophore(s) and one or more fluorescent tracker particle(s) in the sample, and directs the fluorescence signals generated from the one or more environmentally sensitive fluorophore(s) and one or more fluorescent tracker particle(s) in the sample to a camera detector;
one or more signal processing filters that filter the fluorescence signals prior to detection by the camera detector;
a camera detector that acquires a plurality of images over time of the filtered fluorescence signals generated from the one or more environmentally sensitive fluorophore(s) and one or more fluorescent tracker particle(s) in the sample; and
an analyzing device that assesses the spectral properties of the one or more environmentally sensitive fluorophore(s) and one or more fluorescent tracker particle(s) from the plurality of images generated from the camera detector. In some embodiments, the light emitting device that emits a beam of light is a laser or a light emitting diode. In some embodiments, the light emitting device emits a beam of light in the visible spectrum. In some embodiments, the light emitting device emits a beam of light in the infrared or near infrared spectrum. In some embodiments, the light emitting device emits a beam of light having a wavelength of 380 nm, 385 nm, 390 nm, 395 nm, 400 nm, 405 nm, 410 nm, 415 nm, 420 nm, 425 nm, 430 nm, 435 nm, 440 nm, 445 nm, 450 nm, 455 nm, 460 nm, 465 nm, 470 nm, 475 nm, 480 nm, 485 nm, 490 nm, 495 nm, 500 nm, 505 nm, 510 nm, 515 nm, 520 nm, 525 nm, 530 nm, 535 nm, 540 nm, 545 nm, 550 nm, 555 nm, 560 nm, 565 nm, 570 nm, 575 nm, 580 nm, 585 nm, 590 nm, 595 nm, 600 nm, 605 nm, 610 nm, 615 nm, 620 nm, 625 nm, 630 nm, 635 nm, 640 nm, 645 nm, 650 nm, 655 nm, 660 nm, 665 nm, 670 nm, 675 nm, 680 nm, 685 nm, 690 nm, 695 nm, 700 nm, 705 nm, 710 nm, 715 nm, 720 nm, 725 nm, 730 nm, 735 nm, to 740 nm, or a range of wavelengths that includes or is between any two of the foregoing wavelengths (e.g., from 380 nm to 600 nm), including fractional increments thereof. In some embodiments, the one or more mirrors are orientated to reflect light at an angle of 25°, 30°, 35°, 40°, 45°, 50°, 55°, 60°, 65°, 70°, 75° or a range of wavelengths that includes or is between any two of the foregoing angles of reflection (e.g., from 30° to 60°), including fractional increments thereof. In some embodiments, the one or more mirrors are orientated to reflect light at an angle of 45°. In some embodiments, the light filter is a dichroic filter. In some embodiments, the one or more signal processing filters are selected from band pass filters, short pass filters, long pass filters, and multi-band pass filters. In some embodiments, the camera detector is a red, green, blue (RGB) camera. In some embodiments, the analyzing device is a smart phone, computer, or tablet.

Some embodiments of the present disclosure relate to a method for simultaneously assessing viscosity and at least one additional physical and/or chemical property of a sample, comprising:
introducing one or more fluorescently labeled tracker particle(s) and one or more environmentally sensitive fluorophore probe(s) into the sample; and
using an optical system and/or platform disclosed herein to assess the viscosity and the at least one additional physical and/or chemical property of the sample.

In some embodiments, the sample comprises one or more agent(s) chosen from molecules, biomolecules, compounds, and polymers. In some embodiments, the one or more agent(s) are biomolecules chosen from proteins, peptides, lipids, saccharides, carbohydrates, nucleic acids, and steroids.

In some embodiments, the sample is a sample for drug discovery, a bioformulation sample, an immune therapy sample, a solvent sample, a glue sample, an ink sample, a liquid polymer sample, or a cosmetic sample. In some embodiments, the sample is a drug discovery sample.

In some embodiments, the at least one additional physical and/or chemical property of the sample is chosen from aggregation, phase separation behavior, pH, temperature, ionic potential, ionic strength, and kinetics over time. In some embodiments, the at least one additional physical and/or chemical property of the sample is aggregation and/or phase separation behavior. In some embodiments, the at least one additional physical and/or chemical property of the sample is aggregation. In some embodiments, the at least one additional physical and/or chemical property of the sample is phase separation behavior. In some embodiments, the at least one additional physical and/or chemical property of the sample is pH. In some embodiments, the at least one additional physical and/or chemical property of the sample is temperature. In some embodiments, the at least one additional physical and/or chemical property of the sample is ionic potential. In some embodiments, the at least one additional physical and/or chemical property of the sample is ionic strength. In some embodiments, the at least one additional physical and/or chemical property of the sample is kinetics over time.

In some embodiments, the sample has a volume of 0.2 μL, 0.3 μL, 0.4 μL, 0.5 μL, 0.6 μL, 0.7 μL, 0.8 μL, 0.9 μL, 1.0 μL, 1.1 μL, 1.2 μL, 1.3 μL, 1.4 μL, 1.5 μL, 1.6 μL, 1.7 μL, 1.8 μL, 1.9 μL, 2.0 μL, 2.1 μL, 2.2 μL, 2.3 μL, 2.4 μL, 2.5 μL, 2.6 μL, 2.7 μL, 2.8 μL, 2.9 μL, 3.0 μL, 3.1 μL, 3.2 μL, 3.3 μL, 3.4 μL, 3.5 μL, 3.6 μL, 3.7 μL, 3.8 μL, 3.9 μL, 4.0 μL, 4.1 μL, 4.2 μL, 4.3 μL, 4.4 μL, 4.5 μL, 4.6 μL, 4.7 μL, 4.8 μL, 4.9 μL, 5.0 μL, 5.2 μL, 5.4 μL, 5.6 μL, 5.8 μL, 6.0 μL, 6.2 μL, 6.4 μL, 6.6 μL, 6.8 μL, 7.0 μL, 7.2 μL, 7.4 μL, 7.6 μL, 7.8 μL, 8.0 μL, 8.2 μL, 8.4 μL, 8.6 μL, 8.8 μL, 9.0 μL, 9.2 μL, 9.4 μL, 9.6 μL, 9.8 μL, 10.0 μL, 10.5 μL, 11.0 μL, 11.5 μL, 12.0 μL, 12.5 μL, 30.0 μL, 13.5 μL, 14.0 μL, 14.5 μL, 15.0 μL, 15.5 μL, 16.0 μL, 16.5 μL, 17.0 μL, 17.5 μL, 18.0 μL, 18.5 μL, 19.0 μL, 19.5 μL, 20.0 μL, 25.0 μL, 30.0 μL, 35.0 μL, 40.0 μL, 45.0 μL, 50.0 μL, 60.0 μL, 70.0 μL, 80.0 μL, 80.0 μL, 100.0 μL, or a range that includes or is between any two of the foregoing volumes. In some embodiments, each sample assessed has a volume of 1.0 μL to 5.0 μL.

In some embodiments, the one or more environmentally sensitive fluorophore probe(s) are independently chosen from propionyl-2-(dimethylaminonaphthalene) (PRODAN), 6-acetyl-2-dimethylaminonaphthalene (ACDAN), nitrobenz-2-oxa-1,3-diazol-4yl amine (NBD), coumarin derivatives, oxazine derivatives, 9-(diethylamino)-5H-benzo[a]phenoxazin-5-one (Nile Red), [9-(diethylamino)benzo[a]phenoxazin-5-ylidene]azanium sulfate (Nile Blue), dimethylamino-phthalimide/naphthalimides, merocyanines, Daproxyl® derivatives, and 1-(2-maleimidylethyl)-4-(5-(4-methoxyphenyl)oxazol-2-yl) pyridinium methanesulfonate) (PyMPO). In some embodiments, the one or more environmentally sensitive fluorophore probe(s) are independently chosen from ACDAN and Nile Red. In some embodiments, the one or more environmentally sensitive fluorophore probe(s) is/are ACDAN. In some embodiments, the one or more environmentally sensitive fluorophore probe(s) is/are Nile Red.

The details of one or more embodiments of the disclosure are set forth in the accompanying drawings and the description below. Other features, objects, and advantages will be apparent from the description and drawings, and from the claims.

### BRIEF DESCRIPTION OF THE DRAWINGS

FIGS. 1A-E provide: (A) A scheme of the optical set-up for the multiplexed detection of (i) multiple particles dynamics, (ii) fluorophore color and (iii) fluorophore color combined with particle dynamics. (B) A scheme of the illumination and spatial resolution modalities: wide field, high and low illumination (HiLo), structured illumination (spatial resolution Wide Field<HiLo<SIM). (C) A scheme of spectral detection trough four filters/colors: (i) series of band pass filters focused on a single camera detection, (ii) four band pass filters masking the pixel of a camera detector. (D) A scheme of hyperspectral detection trough sin/cosine filters: (i) sin, cosine and un-filtered light path are focused on a single camera detection, (ii) sin/cosine and not filtered mask the pixel of a camera detector. (E) A chart summarizing the features of the different spectral/hyperspectral detection layouts. *Quantum yield (QY) is relative to the fraction of fluorescence that arrives to the detector. **Spectral resolution is reported as function of the wavelength. In the case of band pass filters depends on the color since two monochromatic lights in the same band would not be resolved. ***Linear unmixing of components in the same pixel.

FIGS. 2A-K present: (A) Top: Hyperspectral fluorescence images (pseudo color) of ACDAN 2 uM at different BSA concentrations (0-50 mg/mL, PBS 0.1 M, pH 7.4). Middle panel: fluorescence spectrum of ACDAN in different solutions of BSA. Bottom panel: Hyperspectral Phasor analysis of the emission of ACDAN in BSA solutions. ACDAN Dipolar relaxation is the photophysical mechanism that explains the emission shift due to the influence of the local environment on the ACDAN excited state. (B) A picture representing a turbid dispersion of immune globulin (IgG) 45 mg/mL in PBS buffer. (C) ACDAN hyperspectral phasor of several dispersions of IgG. Right panel, hyperspectral fluorescence images of ACDAN dipolar relaxation (pseudo color) of dispersions of IgG in PBS buffer. (D) Hyperspectral images of ACDAN dipolar relaxation (real color) of BSA, dextran and lysozyme and spectral center of mass ratio (B=450/20 nm, G=500/20 nm). (E) Method for the preparation of BSA cross-linked coacervate. (F) Representation of the ACDAN hyperspectral phasor of the BSA coacervates. The dipolar relaxation phasor coordinate (or in general any spectral shift) can be measured as angle (phase Φ rad.) of the center of mass of the phasor populations. (G) Schematic representation of the phasor/image segmentation and unmixing. (H) Summary of generalized polarization (GP). GP is related to spectral shift between two bands. (I) BSA/glutaraldehyde coacervate, ACDAN dipolar relaxation (rad.) phase separation diagram. (J) ACDAN Dipolar relaxation of the BSA/glutaraldehyde phase diagram (pseudo color) of the coacervates (left panel) and of soluble phase (right panel). (K) Morphology of the BSA/glutaraldehyde coacervates and dipolar relaxation phase diagram of PRODAN and LAURDAN.

FIGS. 3A-F provide: (A) Illustration of time lapse imaging for florescent particle tracking fluorescence correlation spectroscopy. (B) Schematic representation of size dependent interaction of the tracer particle with the molecule in the system. The size dependent interactions define two different regimes for viscosity: micro-viscosity, where the tracer and molecule have similar size and their interactions can influence the particle dynamic; and macro-viscosity, where tracer is at least 6 time larger than the molecules that composed the system, in this regime the dynamics of the tracer depends on the shear rate viscosity of the dispersion fluid. (C) Illustration of the method for the assessment for particle dynamics. Single point/pixel fluorescence correlation spectroscopy (FCS): the fluorescence fluctuations are recoded over time and the autocorrelation function is measured to obtain the diffusion coefficient of the fluorescent particles. The diffusion coefficient is inversely proportional to the viscosity of the solution. (D) Illustration of the method for the assessment for particle dynamics. Single particle tracking (SPT) is a method based on the analysis of the position of each particle over time. The dynamics of each particle depends on the viscosity of the system. (E) Imaging mean square displacement (iMSD) is a way to map the particle dynamic. iMSD computes a pixel averaged spatiotemporal correlation function which decays and spreads as a function of the lag time. The decays depend on the particle dynamics. SPT and iMSD can measure the viscosity by measuring the slope of the mean square displacement as function of the lag time. (F) Comparison between FCS, SPT and iMSD in terms of particle concentration and temporal scale dynamic range.

FIGS. 4A-E provide: (A) Illustration representing the simultaneous assessment of particle dynamics for the viscosity measurement; combined with the spectral shift characterization of nano-environment sensitive probes for the detection of aggregates/phase separations. (B) Schematic illustration for multiplex detection. In this example, multiplexing is obtained by using two bands (B and G) for the measurements of the spectral shift, and a third band for the particle dynamics. (C) Picture of particle dynamics of 200 nm fluorescent particles in two different solutions (a PBS low viscosity solution, and 100% glycerol highly viscous solution). (D) Plot of generalized polarization of ACDAN spectral shift I in different dispersions (BSA in green, IgG turbid in black and glycerol in dark gray). (E) Plot of velocity measured with single particle tracking of 200 nm fluorescent beads in water/BSA solutions (medium gray) and water/glycerol solutions (dark gray).

FIGS. 5A-E present schematics of an exemplary device for an optical system or platform of the present disclosure. (A) Schematic illustration of the exemplary device. (B) Scheme of the optical components of the illumination and detection units of device, and an exemplary configuration for the hyperspectral camera mask. (C and E) An exemplary layout of the hyperspectral camera mask at pixel level (D) Scheme of a possible configuration of filters for hyperspectral imaging using a camera mask. The plots represent a possible spectral filtering for hyperspectral imaging on a camera at the single pixel level.

FIGS. 6A-D present schematics for an exemplary device for an optical system or platform of the present disclosure. (A) Schematic of the exemplary device comprising hyperspectral 3 wide filters on the camera detector. (B) A scheme for the excitation and detection units of the exemplary device. (C) Layout of the filters on the sensor array of the exemplary device. (D) An embodiment of a set of filters for hyperspectral imaging. The plots represent a possible spectral filtering for hyperspectral imaging on a camera

FIGS. 7A-F present schematics of an exemplary device for an optical system or platform of the present disclosure. (A) Schematic illustration of the exemplary device configured with two camera detectors for hyperspectral imaging. (B) Illustration of a possible displacements for hyperspectral imaging with two cameras sensor. (C and E) One possible layout of the filters on a sensor array. (D and F) Possible filter set. The plots represent a possible spectral filtering for hyperspectral imaging on two cameras.

FIGS. 8A-E present schematics of an exemplary device for an optical system or platform of the present disclosure. (A) Schematic design of the exemplary device, (B) Scheme of the optical components of the illumination and detection units of the exemplary device. Configuration for the hyperspectral camera mask. (C and E) Layout of the spectral camera mask at a pixel level. (D) Scheme of a possible configuration of filters for spectral imaging using a camera mask. The plots represent a possible spectral filtering for spectral imaging on camera at a single pixel level.

FIGS. 9A-D present schematics of an exemplary device for an optical system or platform of the present disclosure. (A) Schematic illustration of the exemplary device comprising 3 spectral wide filters on the same camera detector. (B) One possible schematic configuration of the excitation and detection units. (C) Layout of the filters on the sensor array. (D) A possible set of filters for spectral imaging. The plots represent a possible spectral filtering for spectral imaging on a single camera

FIGS. 10A-F present schematics of an exemplary device for an optical system or platform of the present disclosure. (A) Schematic illustration of the exemplary device configured with two camera detectors for spectral imaging. (B) Illustration of a possible displacements for hyperspectral imaging with two cameras sensor. (C and E) One possible layout of the filters on the sensor array. (D and F) Possible filter set. The plots represent a possible spectral filtering for hyperspectral imaging on two cameras.

FIG. 11 presents an exemplary spectral/hyperspectral imaging device that can be used with the optical systems and platforms of the disclosure.

FIG. 12 presents an end long view of the spectral/hyperspectral imaging device presented in FIG. 11.

FIG. 13 presents a top-down angled view of the spectral/hyperspectral imaging device presented in FIG. 11.

FIG. 14 presents an alternate top-down angled view of the spectral/hyperspectral imaging device presented in FIG. 11.

### DETAILED DESCRIPTION

As used herein and in the appended claims, the singular forms “a,” “an,” and “the” include plural referents unless the context clearly dictates otherwise. Thus, for example, reference to “an image” includes a plurality of such images and reference to “the imaging technique” includes reference to one or more imaging techniques and equivalents thereof known to those skilled in the art, and so forth.

Also, the use of “or” means “and/or” unless stated otherwise. Similarly, “comprise,” “comprises,” “comprising” “include,” “includes,” and “including” are interchangeable and not intended to be limiting.

It is to be further understood that where descriptions of various embodiments use the term “comprising,” those skilled in the art would understand that in some specific instances, an embodiment can be alternatively described using language “consisting essentially of” or “consisting of.”

Unless defined otherwise, all technical and scientific terms used herein have the same meaning as commonly understood to one of ordinary skill in the art to which this disclosure belongs. Although many methods and reagents are similar or equivalent to those described herein, non-limiting example methods and materials are disclosed herein.

All publications mentioned herein are incorporated herein by reference in full for the purpose of describing and disclosing the methodologies, which might be used in connection with the description herein. Moreover, with respect to any term that is presented in one or more publications that is similar to, or identical with, a term that has been expressly defined in this disclosure, the definition of the term as expressly provided in this disclosure will control in all respects.

In reference to spectral properties of fluorophores or tracker particles, the term “assess” or “assessing” as used herein, refers to evaluating, determining, or estimating the nature, intensity, and/or quality of the spectral properties of one or more environmentally sensitive fluorophore(s) and/or one or more fluorescent tracker particle(s).

In reference to spectral properties of fluorophores or tracker particles, the term “detect” or “detecting” as used herein, refers to being able to discern or measure the spectral properties of one or more environmentally sensitive fluorophore(s) and/or one or more fluorescent tracker particle(s).

As used herein, “environmentally sensitive fluorophores” refer to a special class of fluorophores that have spectroscopic behavior that is dependent on the physicochemical properties of the surrounding environment. In some embodiments, “environmentally sensitive fluorophores” refer to solvatochromic fluorophores. Solvatochromic fluorophores display sensitivity to the polarity of the local environment. These molecules exhibit a low quantum yield in aqueous solution but become highly fluorescent in nonpolar solvents or when bound to hydrophobic sites in proteins or membranes. Non-limiting examples of solvatochromic fluorophores include 2-propionyl-6-dimethylaminonaphthalene (PRODAN) (Weber et al., Biochemistry 1979, 18, 3075-3078; Cohen et al. Science 2002, 296, 1700-1703), 4-dimethylamino phthalimide (4-DMAP) (Saroja et al., J. Fluoresc. 1998, 8, 405-410), and 4-amino-1,8-naphthalimide derivatives (Grabchev et al., J. Photochem. Photobiol., A 2003, 158, 37-43; Martin et al., J. Lumin. 1996, 68, 157-146).

As used herein, a “spectral/hyperspectral imaging device” is an imaging device that is capable of multicolor spectral imaging and/or hyperspectral imaging. In some embodiments, the optical system and/or platform may be capable of analyzing multiple samples simultaneously.

Comprehensive characterization of physical and/or chemical properties is needed for the development of biotechnological products. Illustratively, understanding the composition of a product in terms of viscosity, aggregation, and/or the presence of phase separation is fundamental for the formulation of stable and reliable biopolymer-based therapies. Typically, measuring viscosity and probing for the presence of multiple phases in the specimen must be performed sequentially with volumes of tens of microliters and analysis times of several minutes. Therefore, being capable of measuring small volumes in a short amount of time allows for better optimization of therapeutic systems before administration, leading to a faster, more flexible personalized therapy. For example, viscosity and the presence of nano- and micro-scaled aggregates affect the efficacy of biological therapeutics.

The present disclosure provides a versatile optical platform and/or system (such as, e.g., a high-throughput optical platform and/or system) that can be used to assess viscosity and at least one additional physical and/or chemical property of a sample (such as, e.g., aggregation of a variety of agents (e.g., molecules, biomolecules, compounds, polymers, etc.)). The versatile optical platforms and/or systems of the disclosure can be utilized for applications that require small volumes and/or high concentration of agents (e.g., molecules, biomolecules, compounds, polymers, etc.). Furthermore, the versatile optical platforms and/or systems disclosed herein are capable of assessing viscosity and at least one additional physical and/or chemical property of a sample (such as, e.g., aggregation of agents) in a minimal sample volume (e.g., 0.5 μL to 20 μL) in less than 10 s, preventing waste of precious materials and increasing the throughput of development, screening, and production processes.

The optical platforms and/or systems of the present disclosure can simultaneously assess the emission spectra of fluorophores and fluorescent particle (nano- and micro-) dynamics. Given that specific antibody treatments require high concentrations of the agent in a low-volume dosage, the platforms and/or systems disclosed herein may enable screening for high quality non-aggregated doses for treatment. This capability may facilitate research and development pipelines for the discovery of new medicines, vaccines, and materials for biomedical, cosmetic, and agricultural applications.

In some embodiments, an optical platform and/or system of the present disclosure comprises a hyperspectral/spectral imaging device that can simultaneously perform spectral/hyperspectral analysis of nano-environment sensitive fluorescent probes and assess the fluorescence particle dynamics. The optical platform and/or system of the present disclosure device is enabled for high-throughput, ultra-low volume experimentation with viscous, high concentration biopolymer formulations, resulting in negligible material waste and increased speed, leading to savings in time and cost. By pairing the detection of spectral probe responsive properties (such as, e.g., biomolecule aggregates and/or phase separation behavior) with fluorescent particle dynamics, the optical platforms and/or systems of the present disclosure can assess fundamental physical and/or chemical features of highly concentrated formulations. Such formulations are common for drug development, therapeutics, and immunology. The optical platforms and/or systems disclosed herein can be used with any water-based system where colloidal properties (such as, e.g., micro-scaled viscosity, macro-scaled viscosity and the presence of nano- and micro-sized aggregates/phase separations) are being assessed.

In some embodiments, the optical platform and/or system of the present disclosure comprises a hyperspectral/spectral imaging device that is a high throughput spectral/hyperspectral imaging device that can perform multiple types of high-fidelity protein, polymer, and drug analyses (i.e., analyses of protein stability, colloidal properties, and viscosity). Additionally, the hyperspectral/spectral imaging device imaging device can also be used simultaneously to assess fluorescent particle dynamics. A high-throughput optical platform and/or system of the present disclosure allows for low volume, high-speed analysis of formulation stability, phase separation, and/or molecular interaction at nanoscale resolution.

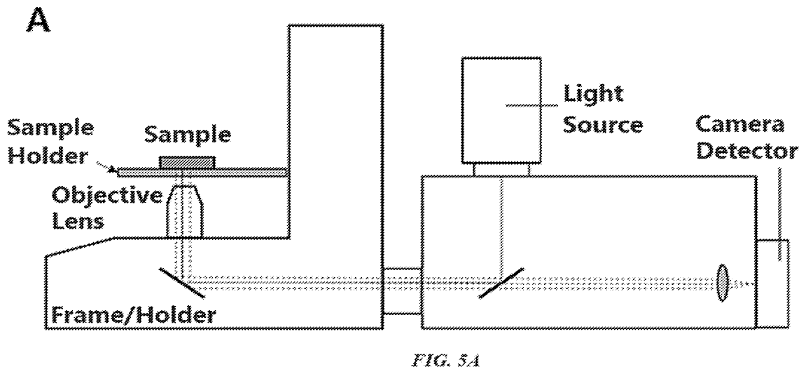

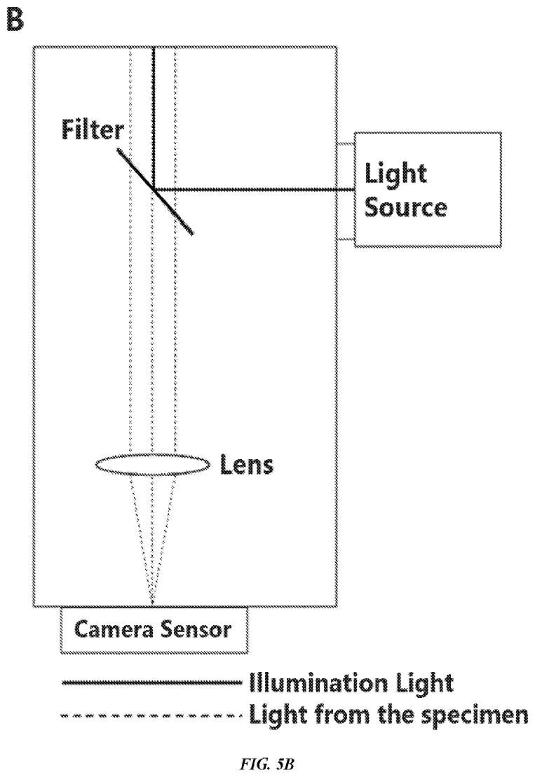

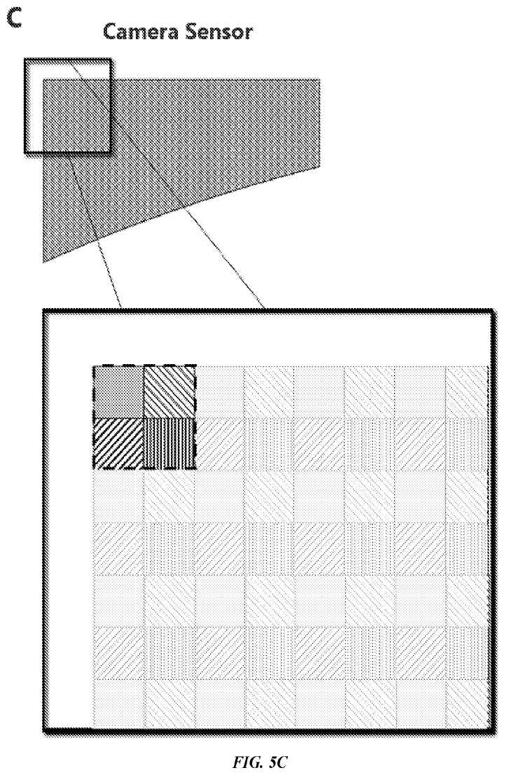

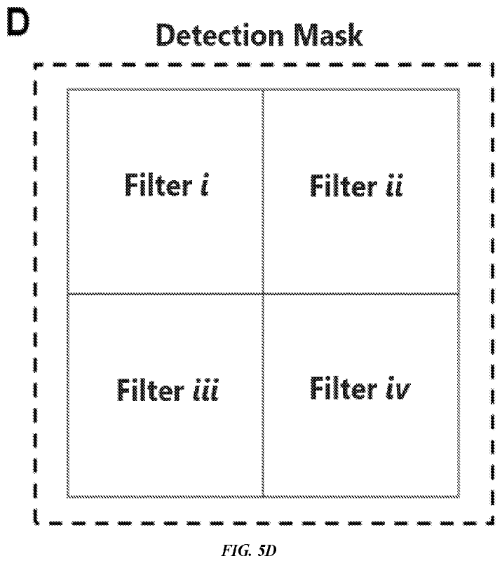

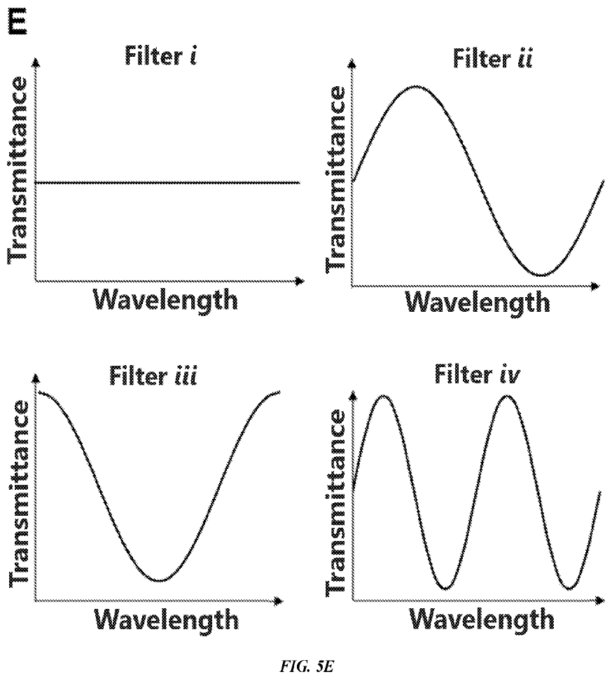

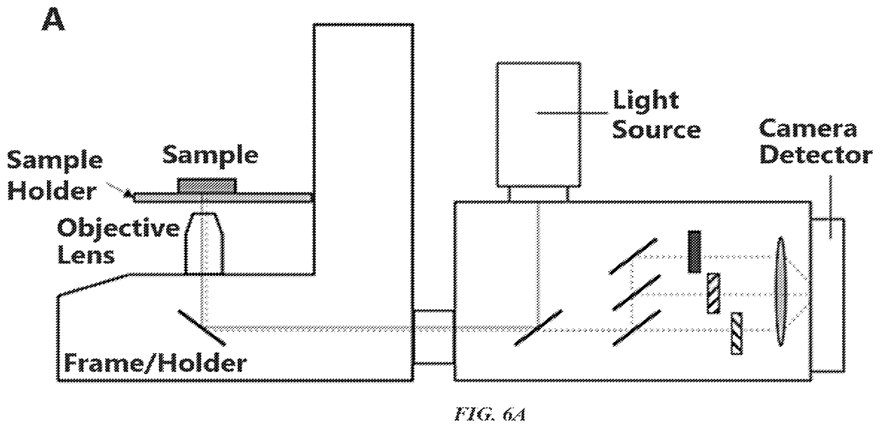

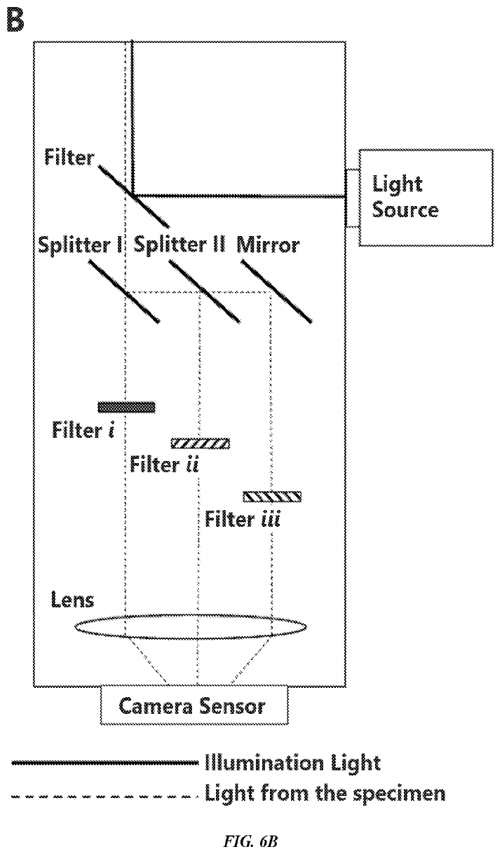

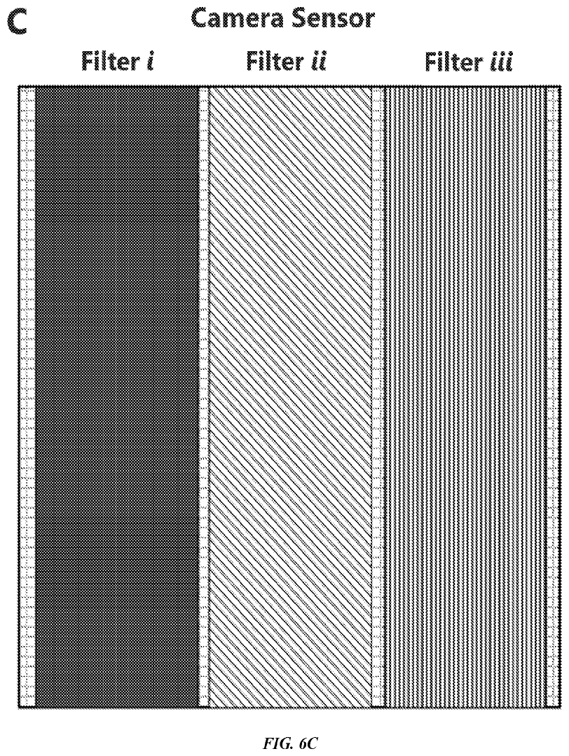

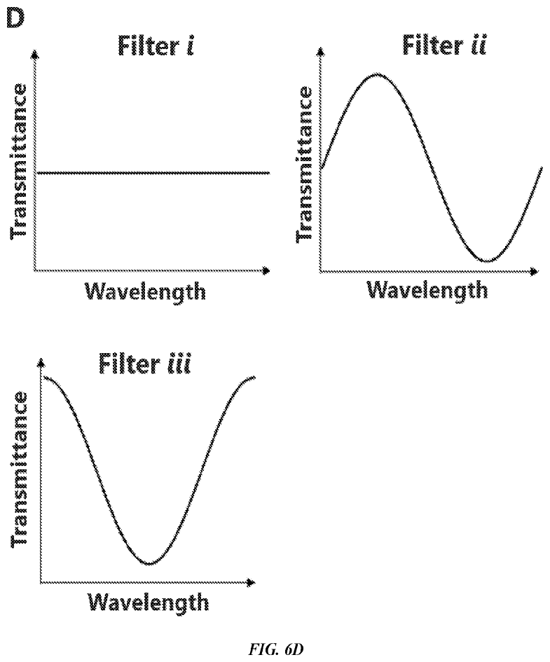

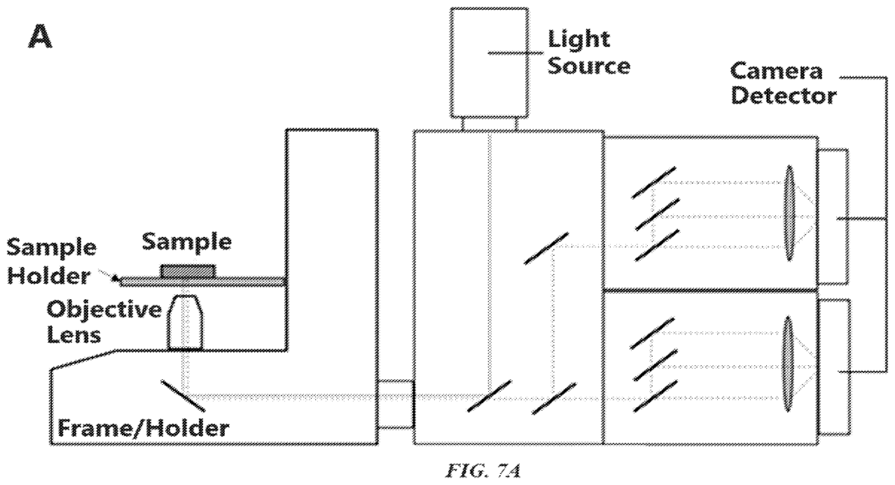

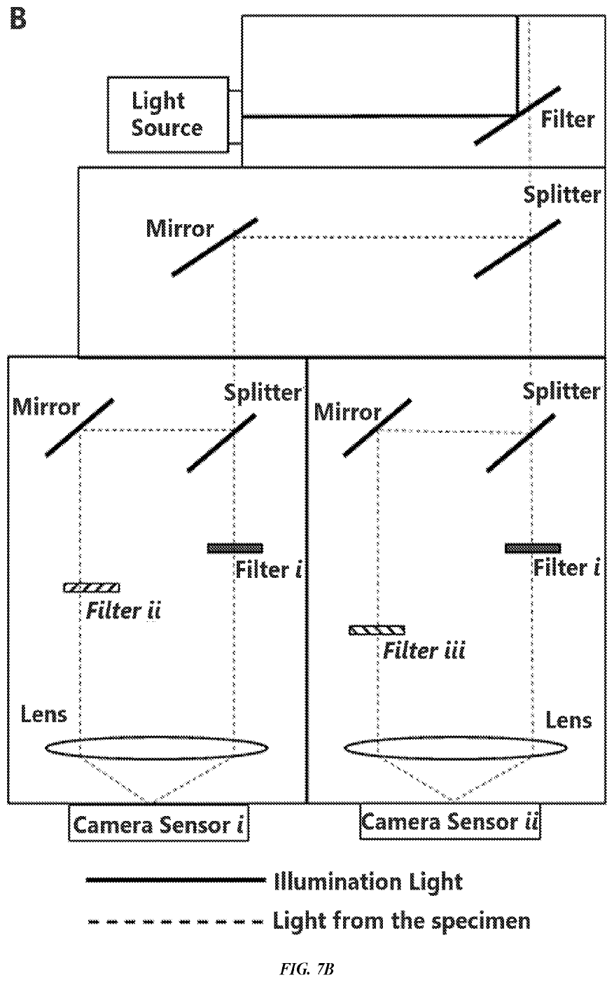

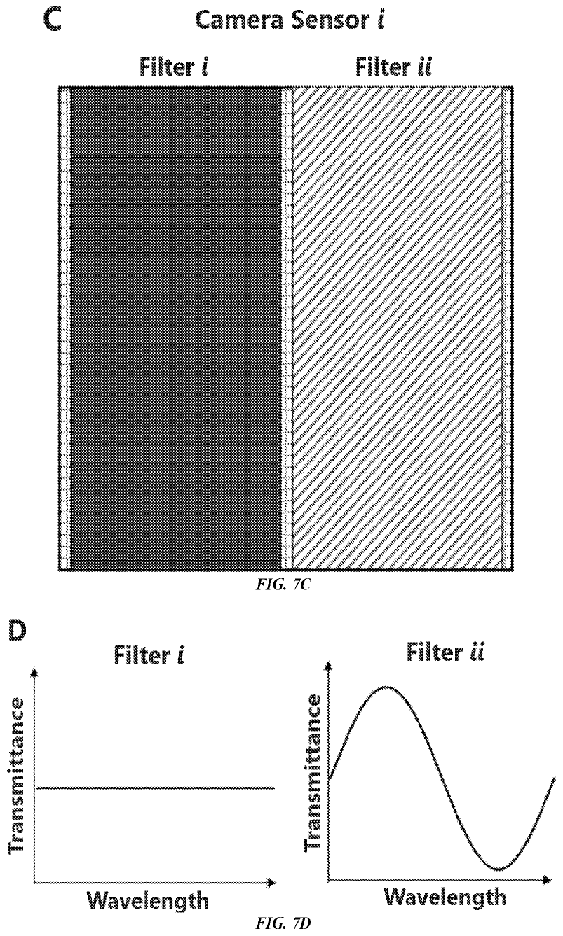

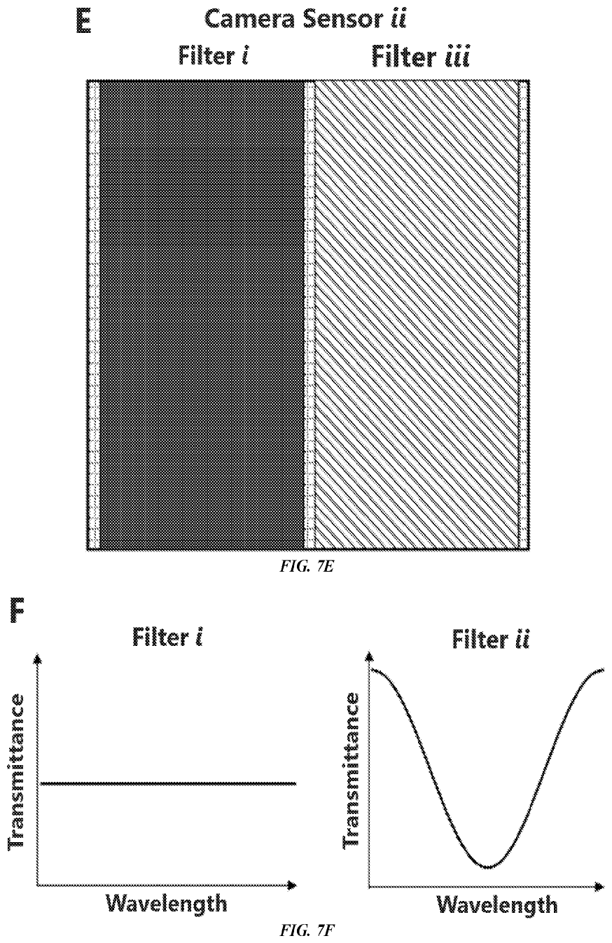

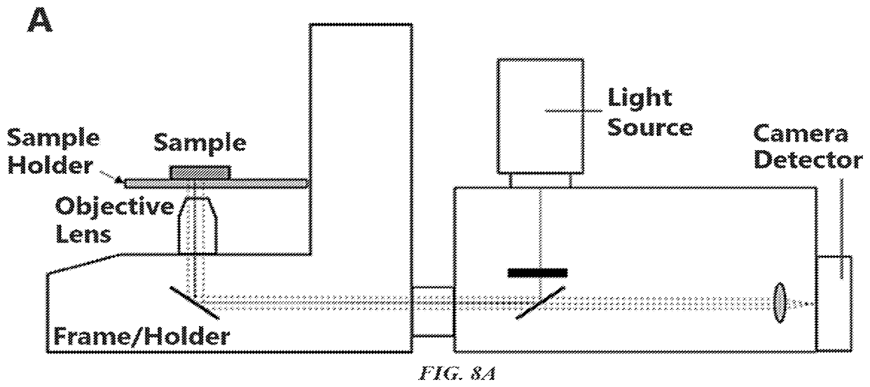

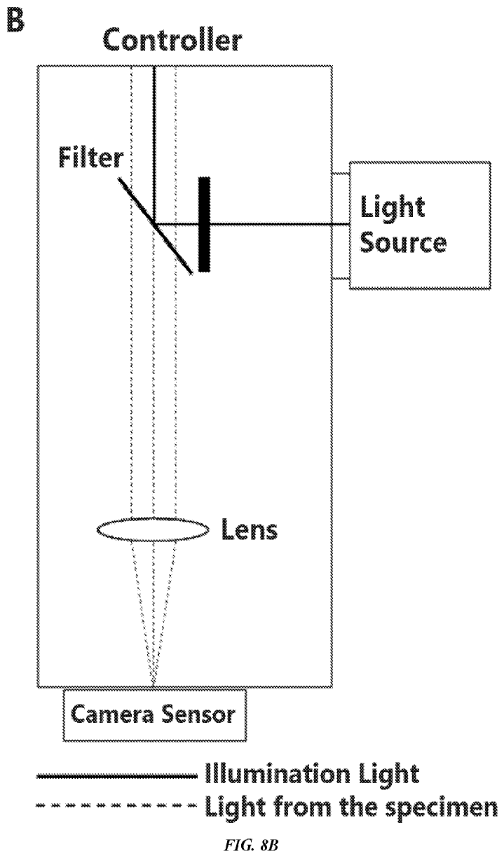

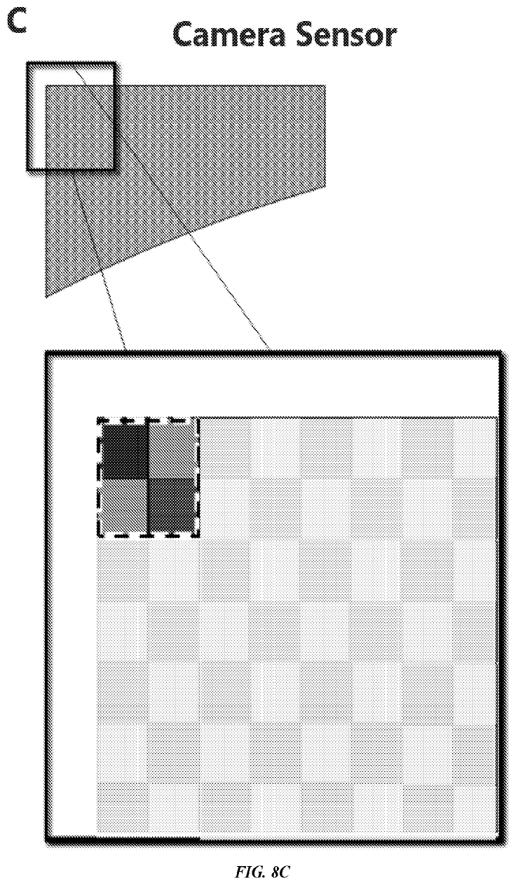

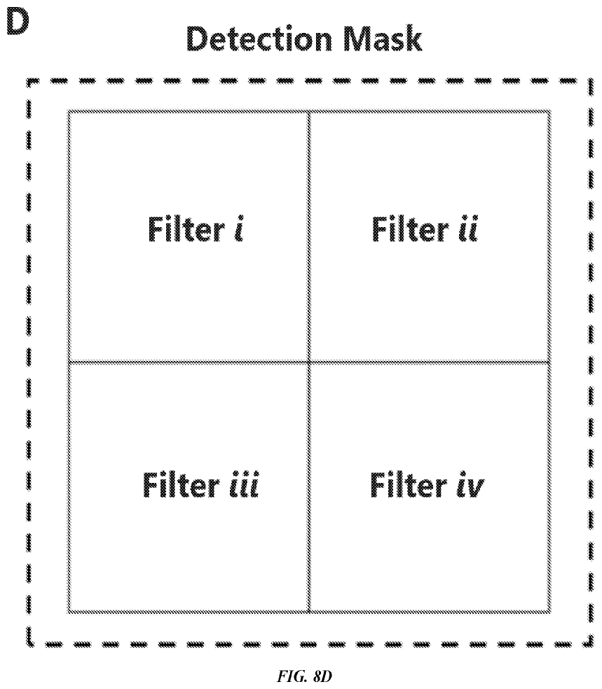

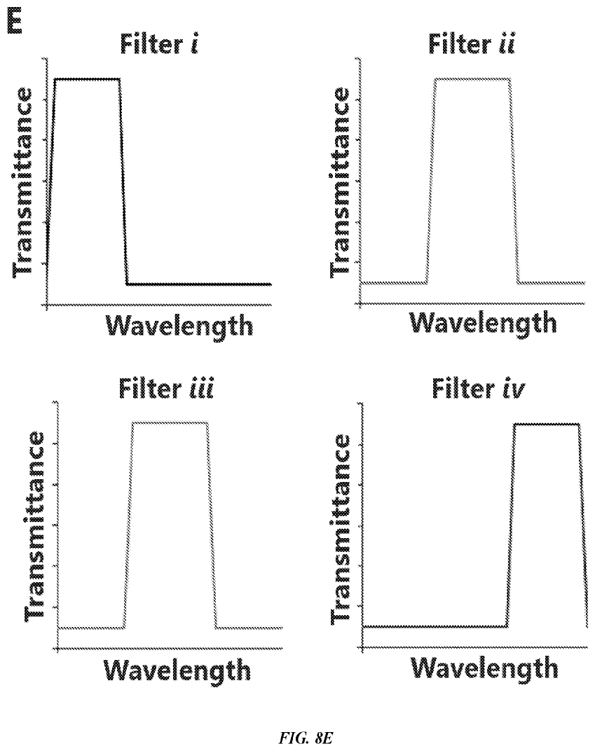

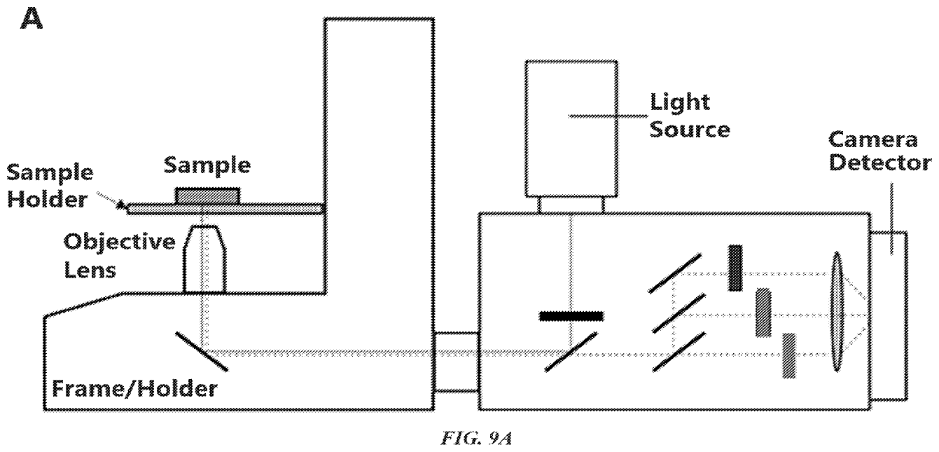

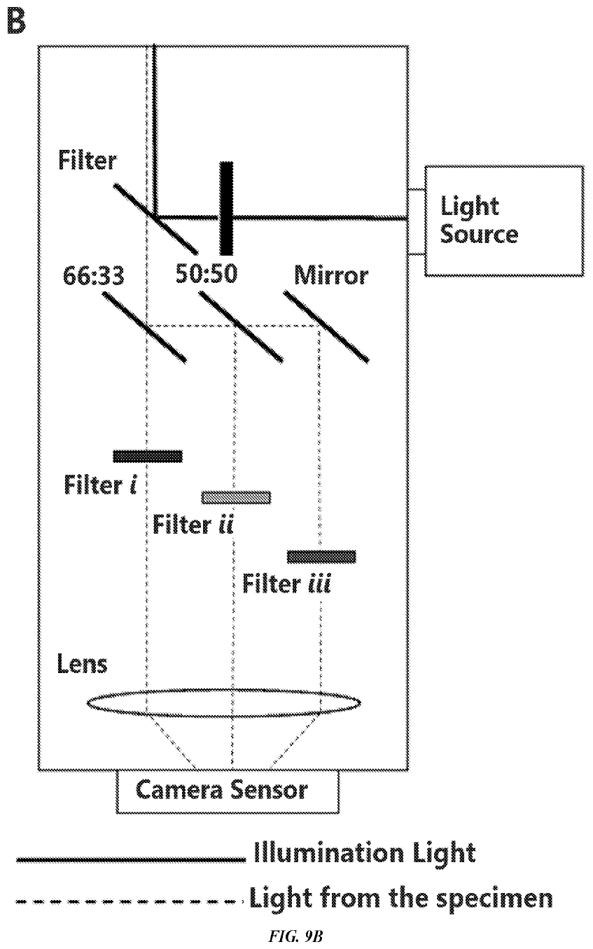

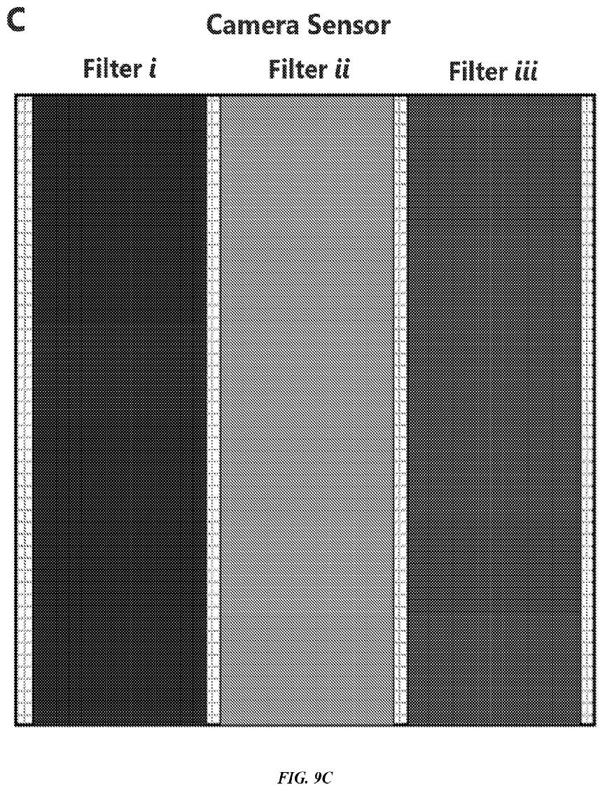

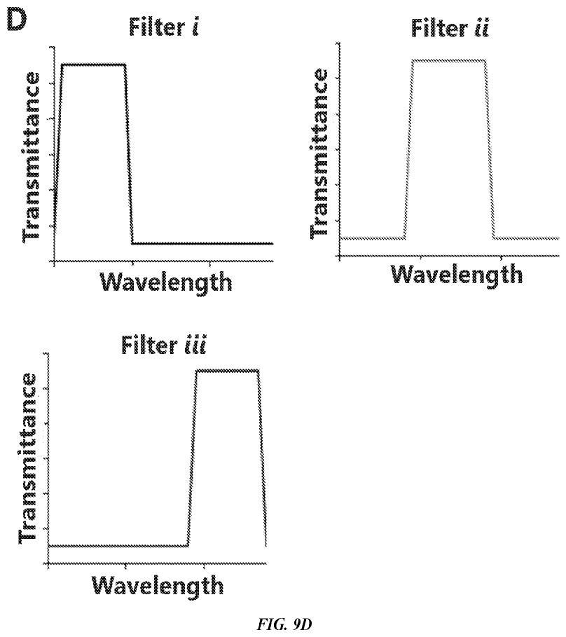

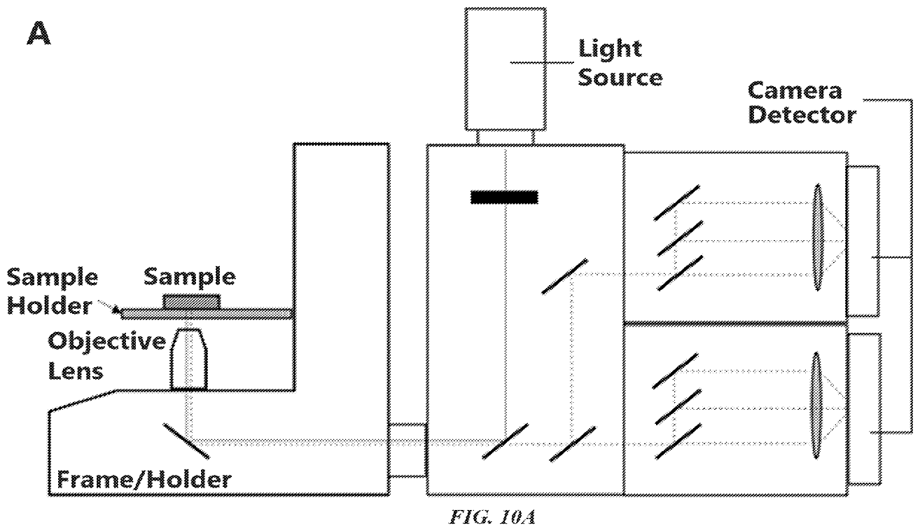

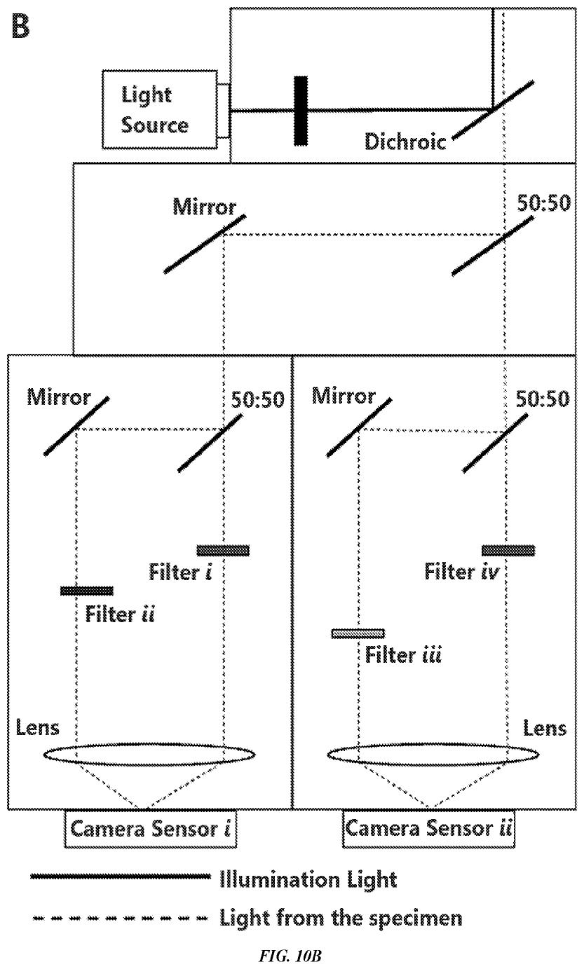

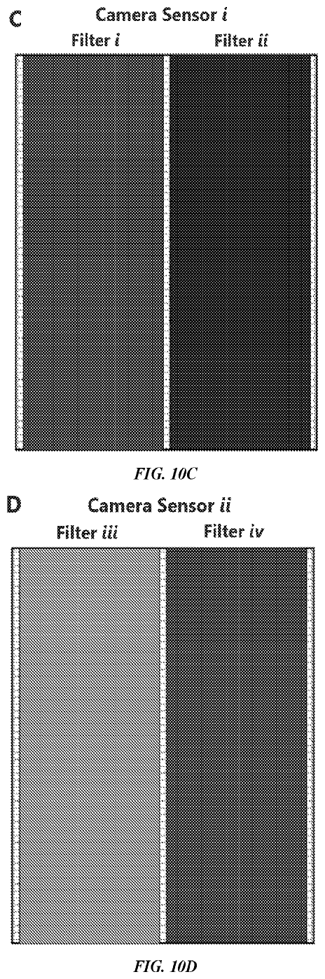

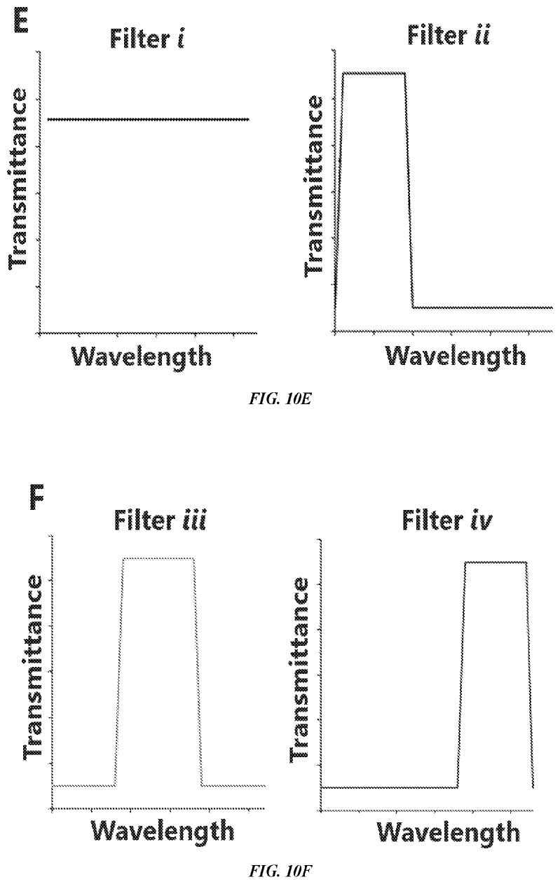

In some embodiments, an optical platform and/or system of the present disclosure comprises an exemplary hyperspectral/spectral imaging device as depicted in FIGS. 5-10. As shown in FIGS. 5-10, the exemplary device comprises a light source, filters, beam splitters and/or mirrors. The light source can be a single photon excitation, a multi-photon excitation light source, or some combination thereof. The type of light source is not limiting and can include: diodes (e.g., LED, organic light-emitting diodes, polymer light-emitting diodes, etc.); lamps, lasers, etc. The type/wavelength of light emitted from the light source is also not limiting and can include: collimated UV, UV-vis, visible, nearIR, IR, etc. The type of filters used by the exemplary device is not limiting and can include: dichroic filters, band pass filters, short pass filters, long pass filters, multi-band pass filters, etc. The type of beam splitters and mirrors used by the exemplary device is not limiting but should be capable of directing excitation light to the sample and/or be able to separate excitation and emission spectra.

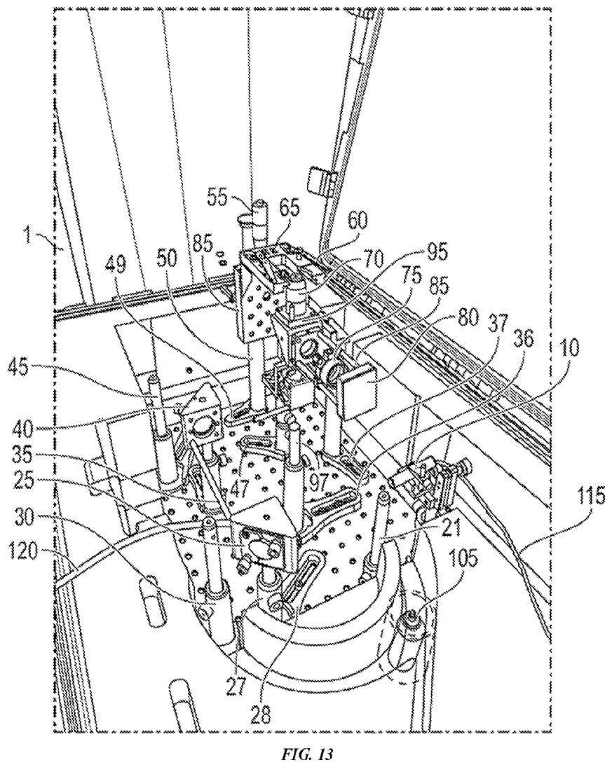

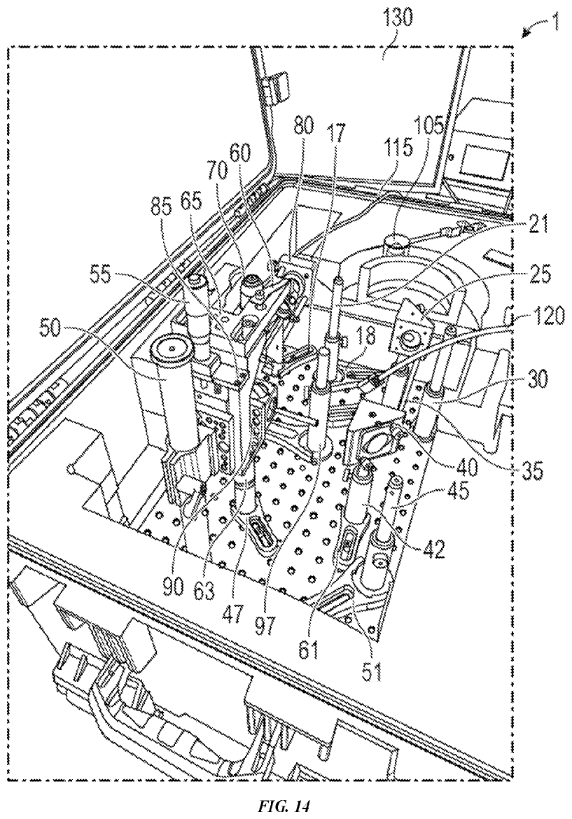

In additional embodiments, an optical platform and/or system of the present disclosure comprises an exemplary hyperspectral/spectral imaging device as depicted in FIGS. 11-14.

As shown in FIGS. 11-14, the hyperspectral/spectral imaging device 1 comprises a housing 5. Housing 5 can have any shape and/or orientation, and is not limited to the specific dimensions, orientation, and/or shape depicted in FIG. 11. Housing 5 may have singular construction, e.g., generally one-piece, or have modular construction, e.g., multilayer construction with different components making up each layer. For example, housing 5 may comprise an outer housing comprised of a solid material, e.g., metal, plastic, or a combination thereof; and an inner housing comprised of a solid material and/or a porous material, e.g., protecting or insulating material (e.g., foam, foil, fiberglass, rock, slag wool, natural fibers, cellulose, polystyrene, polyisocyanurate, polyurethane, perlite, etc.) or a combination of protecting or insulating materials. In a particular embodiment, housing 5 comprises an outer housing of metal, plastic, or a combination thereof; and an inner housing of foam. Hyperspectral/spectral imaging device 1 further comprises a plate/platform 15 that is used to attach or immobilize various structural elements, e.g., immobilizing element 17. In some embodiments, plate/platform 15 is part of housing 5. In other embodiments, plate/platform 15 is separate from housing 5 and can be attached or affixed thereto. Plate/platform 15 may comprise holes or raised structures that can facilitate attachment, including removable attachment, of various structures to plate/platform 15. For example, plate/platform 15 may comprise holes that can accommodate screws or rivets, thereby allowing attachment of the structural elements to plate/platform 15. Alternatively, plate/platform 15 can be a substantially flat surface that lacks holes or raised structures. Plate/platform 15 is typically comprised of a rigid solid material like metal, plastic, or a combination thereof.

Hyperspectral/spectral imaging device 1 further comprises one or more light emitting device 10. Light emitting device 10 can emit coherent light or incoherent light, and in the case of multiple light emitting devices 10, can emit both coherent and incoherent light. Light emitting device 10 is not particularly limited and can include: diodes (e.g., LED, organic light-emitting diodes, polymer light-emitting diodes, etc.); lamps; lasers; etc. In a particular embodiment, the light emitting device 10 is a laser that emits coherent light. The wavelength of light emitted from the light emitting device 10 is also not limited and can include light that is emitted from various regions of the electromagnetic spectrum (e.g., infrared, near infrared, visible, ultraviolet, etc.). Generally, the wavelength of light that is emitted from light emitting device 10 should, but not always, be based on detector sensitivity and the other optical components, e.g., the dichroic filter of dichroic filter and filter housing 95, and signal processing filters or modalities (not shown). In some embodiments, light emitting device 10 emits light having a wavelength of 380 nm, 385 nm, 390 nm, 395 nm, 400 nm, 405 nm, 410 nm, 415 nm, 420 nm, 425 nm, 430 nm, 435 nm, 440 nm, 445 nm, 450 nm, 455 nm, 460 nm, 465 nm, 470 nm, 475 nm, 480 nm, 485 nm, 490 nm, 495 nm, 500 nm, 505 nm, 510 nm, 515 nm, 520 nm, 525 nm, 530 nm, 535 nm, 540 nm, 545 nm, 550 nm, 555 nm, 560 nm, 565 nm, 570 nm, 575 nm, 580 nm, 585 nm, 590 nm, 595 nm, 600 nm, 605 nm, 610 nm, 615 nm, 620 nm, 625 nm, 630 nm, 635 nm, 640 nm, 645 nm, 650 nm, 655 nm, 660 nm, 665 nm, 670 nm, 675 nm, 680 nm, 685 nm, 690 nm, 695 nm, 700 nm, 705 nm, 710 nm, 715 nm, 720 nm, 725 nm, 730 nm, 735 nm, to 740 nm, or a range of wavelengths that includes or is between any two of the foregoing wavelengths (e.g., from 380 nm to 740 nm), including fractional increments thereof. In some embodiments, light emitting device 10 emits light having a wavelength of 405 nm. Light of that wavelength excites a large spectrum of fluorophores. Light emitting device 10 can emit light as a beam of light with controllable directionality. For example, light emitting device 10 can emit a beam of light so that it directed towards a specific structure of hyperspectral/spectral imaging device 1, e.g., mirror 25. Light emitting device 10 can be connected or affixed to plate/platform 15 via structural element 23 and immobilizing element 17. Immobilizing element 17 can be attached to plate/platform 15 by any number and/or type of attachment means including, but not limited to, by use of magnets, by use of fasteners (e.g., screws, rivets, rods, etc.), by use of adhesives, by welding, by molding., etc. In a certain embodiment, immobilizing element 17 is attached to plate/platform 15 by use of screws or rivets. Immobilizing element 17 is further dimensioned so as to accommodate structural element 12. Accordingly, structural element 12 can be affixed to plate/platform 15 via immobilizing element 17. In certain embodiments, structural element 12 comprises immobilizing element 17, such that structural element 12 and immobilizing element 17 are a single structural component, not separate structural components as shown in FIGS. 11-14. Structural element 12 can be a defined height or can be of an adjustable height. In the latter instance, structural element 12 can comprise a means to adjust the height of structural element 12, including a slidable adjustable means that can be locked into a desired height by use of screw or another form of locking mechanism. Structural element 12 is configured to accommodate light emitting device 10 and retain light emitting device 10 in a stable, non-movable configuration. Cable 115 can be used to provide power to light emitting device 10. Additionally, cable 115 can be used to control the operation of light emitting device 10, by directly connecting light emitting device 10 to a controller device (not shown) that controls the operation of light emitting device 10. Examples of a controller device include, but are not limited to, a computer, a smart phone, a tablet, etc. Alternatively, the controller device may be indirectly connected to light emitting device 10, via use of a transponder or the like. In such a case, light emitting device 10 can be connected to the controller device by a Bluetooth connection or a wireless connection.

Light emitting device 10 is configured to direct light onto mirror 25. Mirror 25 is configured to reflect the light generated from the light emitting device 10 onto mirror 40. Mirror 25 can have a defined angle of reflection, e.g., 45°, or an angle of reflection that is adjustable, e.g., from 30° to 60°. Generally, the angle of reflection for mirror 25 relates to the location of mirror 40 as it relates to light emitting device 10. Mirror 40 is configured to reflect light from mirror 25 onto mirror 90. Mirror 40 can have a defined angle of reflection, e.g., 45°, or an angle of reflection that is adjustable, e.g., from 30° to 60°. Generally, the angle of reflection for mirror 40 relates to the location of mirror 25 as it relates to mirror 90. mirror 25 may optionally be directly connected to mirror 40 with structural connector 35. Structural connector 35 is strictly optional as it is not necessary for Mirror 25 to be directly connected to Mirror 40. Directly connecting mirror 25 to mirror 40 via structural connector 35 ensures the mirrors stay properly aligned by limiting any possible independent lateral movement of mirror 25 and mirror 40.

Mirror 25 can be affixed to structural element 27 that is affixed to plate/platform 15 by immobilizing element 28. Immobilizing element 28 can be attached to plate/platform 15 by any number types of attachment means including, but not limited to, by use of magnets, by use of fasteners (e.g., screws, rivets, rods, etc.), by use of adhesives, by welding, by molding., etc. In a certain embodiment, immobilizing element 28 is attached to plate/platform 15 by use of screws or rivets. Immobilizing element 28 is further dimensioned so as to accommodate structural element 27. In certain embodiments, structural element 27 comprises immobilizing element 28, such that structural element 27 and immobilizing element 28 are a single structural component, not separate structural components as shown in FIGS. 11-14. Structural element 27 can be a defined height or can be of an adjustable height. In the latter instance, structural element 27 can comprise a means to adjust the height of structural element 27 including a slidable adjustable means that can be locked into a desired height by use of screw or another form of locking mechanism.

Mirror 40 can be affixed to structural element 42 that is affixed to plate/platform 15 by immobilizing element 61. Immobilizing element 61 can be attached to plate/platform 15 by any number and/or type of attachment means including, but not limited to, by use of magnets, by use of fasteners (e.g., screws, rivets, rods, etc.), by use of adhesives, by welding, by molding., etc. In a certain embodiment, immobilizing element 61 is attached to plate/platform 15 by use of screws or rivets. Immobilizing element 61 is further dimensioned so as to accommodate structural element 42. In certain embodiments, structural element 42 comprises immobilizing element 61, such that structural element 42 and immobilizing element 61 are a single structural component, not separate structural components as shown in FIGS. 11-14. Structural element 42 can be a defined height or can be of an adjustable height. In the latter instance, structural element 42 can comprise a means to adjust the height of structural element 42, including a slidable adjustable means that can be locked into a desired height by use of screw or other form of locking mechanism.

While hyperspectral/spectral imaging device 1 is depicted in FIGS. 11-14 as comprising mirror 25 and mirror 40, it should be understood, however, that alternative placement of light emitting device 10 may eliminate the need for mirror 25 and/or mirror 40. For example, if light emitted by light emitting device 10 is directed to mirror 90 instead of mirror 25, then hyperspectral/spectral imaging device 1 need not comprise mirror 25 and mirror 40 and their associated structural elements and immobilizing elements.

Mirror 90 can be affixed to structural element 63 that is affixed to plate/platform 15 by immobilizing element 47. Immobilizing element 47 can be attached to plate/platform 15 by any number and/or type of attachment means including, but not limited to, by use of magnets, by use of fasteners (e.g., screws, rivets, rods, etc.), by use of adhesives, by welding, by molding., etc. In a certain embodiment, immobilizing element 47 is attached to plate/platform 15 by use of screws or rivets. Immobilizing element 47 is further dimensioned so as to accommodate structural element 63. In certain embodiments, structural element 63 comprises immobilizing element 47, such that structural element 63 and immobilizing element 47 are a single structural component, not separate structural components as shown in FIGS. 11-14. Structural element 63 can be a defined height or can be of an adjustable height. In the latter instance, structural element 63 can comprise a means to adjust the height of structural element 63 including a slidable adjustable means that can be locked into a desired height by use of screw or another form of locking mechanism.

Hyperspectral/spectral imaging device 1 comprises light filter and light filter housing 95. Light filter and filter housing 95 are in light communication with mirror 90 so that light that is reflected by mirror 90 is directed onto the light filter of light filter and filter housing 95. Light filter of light filter and filter housing 95 can direct light generated from the light emitting device with specific excitation frequency towards a sample placed on sample holder 60 using sample retaining device 65 and then direct fluorescence signals generated from the sample to camera detector 80. Additionally, light filter and filter housing 95 and/or mirror 90 can comprise one or more signal processing filters or modalities (not shown) that filter the fluorescence signals prior to detection by the camera detector 80. Examples of signal processing filters or modalities include, but are not limited to, band-pass filters, band-pass camera masks, sin/cosine filters, and/or sin/cosine camera masking. Objective 70 is connected to dichroic filter and filter housing 95. Objective 70 gathers light from the sample placed in sample holder 60 being observed and focuses the light rays from it to produce a magnified image of the sample, the degree of magnification being determined by the magnification power of Objective 70. Objective 70 can provide a magnification power of 4×, 10×, 40×, 50×, 60×, 100×, or a range of magnification powers that includes or is between any two of the foregoing magnification powers. Additional objectives can be stored with hyperspectral/spectral imaging device 1, such as one or more of spare objective 105. In such instances, a spare objective 105 may have different magnification power than objective 70. The sample being visualized by the hyperspectral/spectral imaging device 1 is placed into sample holder 60. While sample holder 60 is shown as having sample retaining device 65, sample retaining device 65 is optional. Moreover, sample retaining device 65 need not be clips and can be any other structural means to retain a sample over the objective 70, which can largely be determined based on sample type. Sample holder 60 can be attached to a staging structure 85 that is then connected to structural element 50. Structural element 50 can then be connected or fixed to plate/platform 15 via immobilizing element 49. Immobilizing element 49 can be attached to plate/platform 15 by any number and/or type of attachment means including, but not limited to, by use of magnets, by use of fasteners (e.g., screws, rivets, rods, etc.), by use of adhesives, by welding, by molding, etc. In a certain embodiment, immobilizing element 49 is attached to plate/platform 15 by use of screws or rivets. Immobilizing element 49 is further dimensioned so as to accommodate structural element 50. Accordingly, structural element 50 can affixed or connected to plate/platform 15 via immobilizing element 49. In certain embodiments, structural element 50 comprises immobilizing element 49, such that structural element 50 and immobilizing element 49 are a single structural component, not separate structural components as shown in FIGS. 11-14. Structural element 50 can be a defined height or can be of an adjustable height. In the latter instance, structural element 50 can comprise a means to adjust the height of structural element 50 including a slidable adjustable means that can be locked into a desired height by use of screw or other form of locking mechanism. Staging structure 85 further comprises a focus adjusting mechanism 55. Focus adjusting mechanism 55 provides for fine tuning of the various optical components to provide a clearer focus of the sample to be imaged by hyperspectral/spectral imaging device 1. For example, modulation of focus adjusting mechanism 55 provides for translational movement of sample holder 60 in reference to objective 70. Focus adjusting mechanism 55 can be manually modulated, as shown, or alternatively, focus adjusting mechanism 55 can be electronically modulated. In the latter case, focus adjusting mechanism 55 can be electronically modulated by use of the analyzer device (not shown).

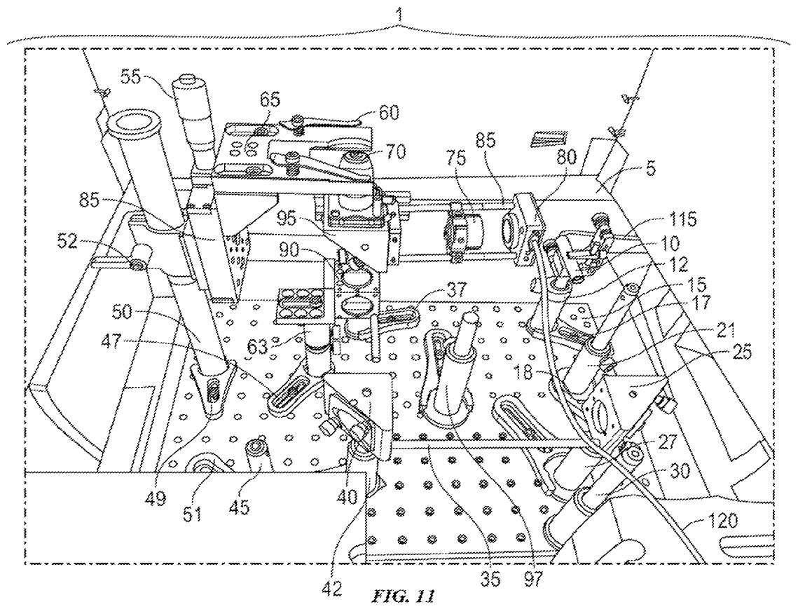

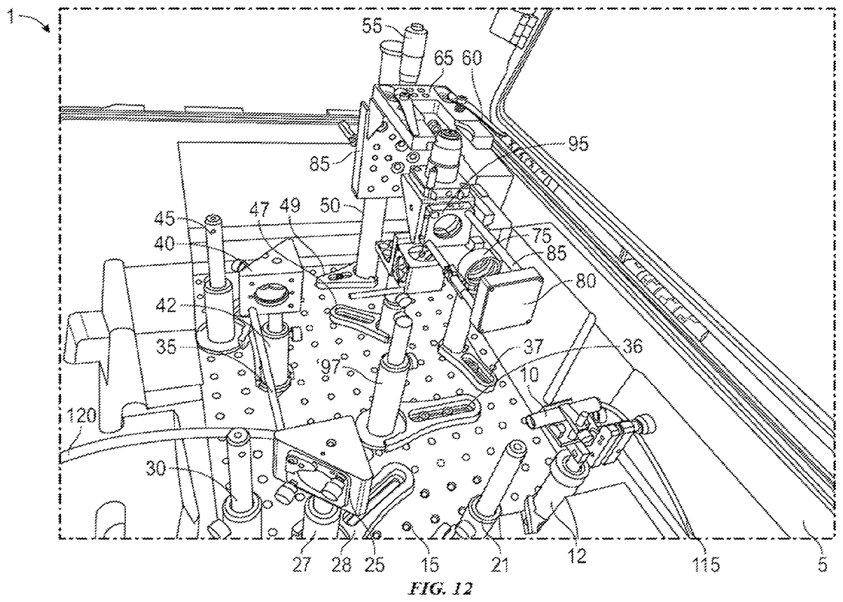

Hyperspectral/spectral imaging of the sample is performed by camera detector 80. Camera detector 80 configured to simultaneously detect one or more spectral/hyperspectral properties of one or more environmentally sensitive fluorophore(s) and fluorescent tracker particle(s) in the sample. In a particular embodiment, camera detector 80 is a red, green, blue (RGB) camera. Between camera detector 80 and the dichroic filter is focusing lens 75. Focusing lens 75 allows camera detector 80 to generate better quality focused images for analysis. Cable 120 can be used to provide power to camera detector 80. FIG. 11 shows where cable 120 is detachably connected to camera 80. FIGS. 12-14 show where cable 120 is not connected to camera detector 80. Additionally, cable 120 can be used to transmit images acquired by camera detector 80 to an analyzer device (not shown) which analyses the images acquired by camera detector 80. Examples of an analyzer device include, but are not limited to, a computer, a smart phone, a tablet, etc. Alternatively, the analyzer device may be indirectly connected to camera detector 80, via use of a transponder or the like. In such a case, camera detector 80 can be connected to the analyzer device by a Bluetooth connection or a wireless connection. The analyzer device may be the same device as the controller device that controls the operation of light emitting device 10. Alternatively, the analyzer device may a different device than the controller device that controls the operation of light emitting device 10.

Hyperspectral/spectral imaging device 1 may further comprise one or more optional structural elements and immobilizing elements. Such structural elements can be used to attach additional mirrors, light emitting devices, sensors, etc. These structural elements can alternatively be used to as attach covers and the like to protect other structural elements of hyperspectral/spectral imaging device 1. The placement of these optional structural elements and immobilizing elements do not have be located as depicted in FIGS. 11-14, and can attached or affixed in alternate areas of plate/platform 15. For example, hyperspectral/spectral imaging device 1 may comprise optional structural element 21 and immobilizing element 18. Immobilizing element 18 can be attached to plate/platform 15 by any number and/or type of attachment means including, but not limited to, by use of magnets, by use of fasteners (e.g., screws, rivets, rods, etc.), by use of adhesives, by welding, by molding., etc. In a certain embodiment, immobilizing element 18 is attached to plate/platform 15 by use of screws or rivets. Immobilizing element 18 is further dimensioned so as to accommodate structural element 21. Accordingly, structural element 21 can affixed or connected to plate/platform 15 via immobilizing element 18. In certain embodiments, structural element 21 comprises immobilizing element 18, such that structural element 21 and immobilizing element 18 are a single structural component, not separate structural components as shown in FIGS. 11-14. Structural element 21 can be a defined height or can be of an adjustable height. In the latter instance, structural element 21 can comprise a means to adjust the height of structural element 21, including a slidable adjustable means that can be locked into a desired height by use of screw or other form of locking mechanism.

Hyperspectral/spectral imaging device 1 may comprise optional structural element 30 and immobilizing element 31. Immobilizing element 31 can be attached to plate/platform 15 by any number and/or type of attachment means including, but not limited to, by use of magnets, by use of fasteners (e.g., screws, rivets, rods, etc.), by use of adhesives, by welding, by molding., etc. In a certain embodiment, immobilizing element 31 is attached to plate/platform 15 by use of screws or rivets. Immobilizing element 31 is further dimensioned so as to accommodate structural element 30. Accordingly, structural element 30 can be affixed or connected to plate/platform 15 via immobilizing element 31. In certain embodiments, structural element 30 comprises immobilizing element 31, such that structural element 30 and immobilizing element 31 are a single structural component, not separate structural components as shown in FIGS. 11-14. Structural element 30 can be a defined height or can be of an adjustable height. In the latter instance, structural element 30 can comprise a means to adjust the height of structural element 30, including a slidable adjustable means that can be locked into a desired height by use of screw or other form of locking mechanism. Hyperspectral/spectral imaging device 1 may comprise optional structural element 45 and immobilizing element 51. Immobilizing element 51 can be attached to plate/platform 15 by any number and/or type of attachment means including, but not limited to, by use of magnets, by use of fasteners (e.g., screws, rivets, rods, etc.), by use of adhesives, by welding, by molding., etc. In a certain embodiment, immobilizing element 51 is attached to plate/platform 15 by use of screws or rivets. Immobilizing element 51 is further dimensioned so as to accommodate structural element 45. Accordingly, structural element 45 can be affixed or connected to plate/platform 15 via immobilizing element 51. In certain embodiments, structural element 45 comprises immobilizing element 51, such that structural element 45 and immobilizing element 51 are a single structural component, not separate structural components as shown in FIGS. 11-14. Structural element 45 can be a defined height or can be of an adjustable height. In the latter instance, structural element 45 can comprise a means to adjust the height of structural element 45 including a slidable adjustable means that can be locked into a desired height by use of screw or other form of locking mechanism.

Hyperspectral/spectral imaging device 1 may comprise optional structural element 97 and immobilizing element 36. Immobilizing element 36 can be attached to plate/platform 15 by any number types of attachment means including, but not limited to, by use of magnets, by use of fasteners (e.g., screws, rivets, rods, etc.), by use of adhesives, by welding, by molding, etc. In a certain embodiment, immobilizing element 36 is attached to plate/platform 15 by use of screws or rivets. Immobilizing element 51 is further dimensioned so as to accommodate structural element 97. Accordingly, structural element 97 can be affixed or connected to plate/platform 15 via immobilizing element 36. In certain embodiments, structural element 97 comprises immobilizing element 36, such that structural element 97 and immobilizing element 36 are a single structural component, not separate structural components as shown in FIGS. 11-14. Structural element 97 can be a defined height or can be of an adjustable height. In the latter instance, structural element 97 can comprise a means to adjust the height of structural element 97 including a slidable adjustable means that can be locked into a desired height by use of screw or other form of locking mechanism.

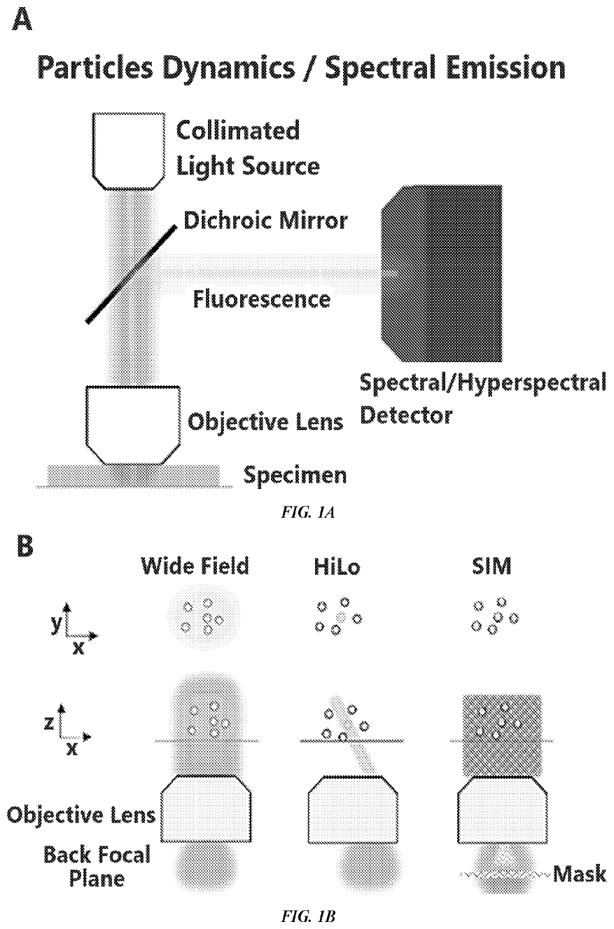

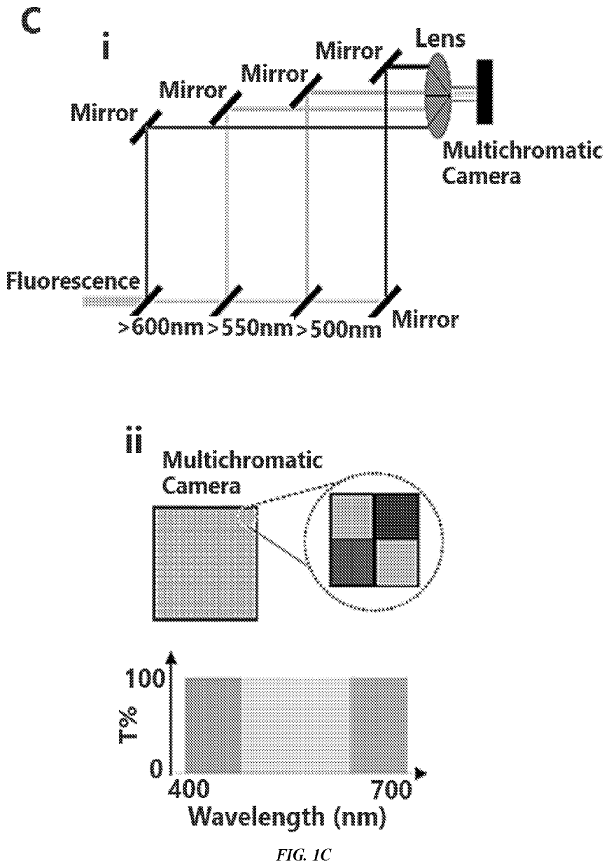

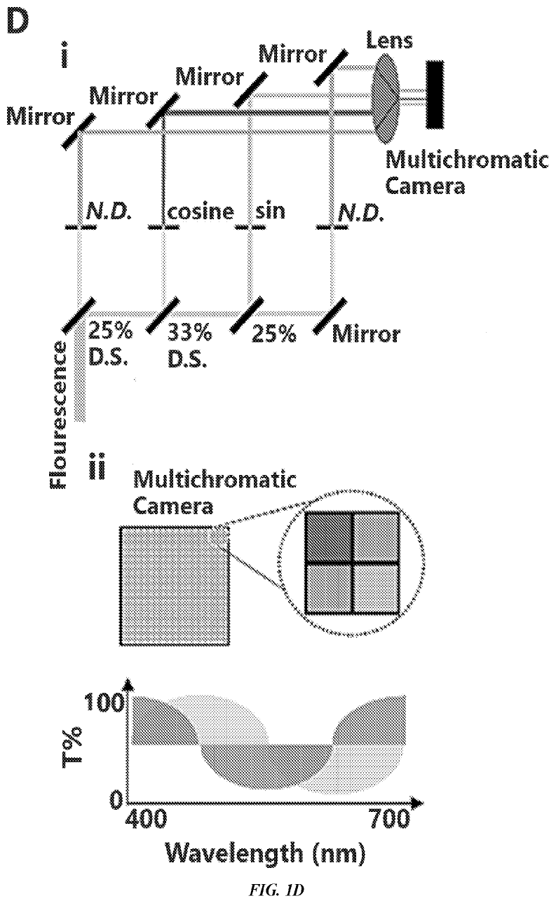

In some embodiments, an optical platform and/or system of the present disclosure utilizes fluorescence microscopy-based techniques with the hyperspectral/spectral imaging device so as to provide very high spatiotemporal resolution (e.g., 10⁻⁹ m, 10⁻¹² sec). In some embodiments, the hyperspectral/spectral imaging device is a camera-based fluorescence microscope (e.g., see FIG. 1A) or a similar system. The optical path is designed to be implemented in one of three different modalities (e.g., see FIG. 1B): (i) wide field (low spatial resolution), high performance in low light conditions, (ii) High and Low illumination (HiLo), high depth resolution and (iii) Structured Illumination Microscopy (SIM), that utilizes an optical grating/patterned interference mask to achieve super-resolution. These three different modalities are beneficial for determining the optical properties of environmental sensitive fluorophores and for the investigation of the particle dynamics in variety of possible scenarios. The simultaneous assessment of the spectral properties of solvatochromic dyes and particle dynamics may be achieved due to a multicolor spectral/hyperspectral detection unit (e.g., see FIG. 1C-E). The spectral/hyperspectral detection can be achieved with four different modalities: band-pass filters; band-pass camera masks; sin/cosine filters; and sin/cosine camera masking (e.g., see FIG. 1C-D). These modalities allow different detection efficiencies in terms of quantum yield (percentage of photons detected/emitted), spectral resolution, single pixel sensitivity, and portability. The detection unit can assess up to four different components in a single pixel simultaneously. If the colors are spatially separated, the sin/cosine design allows theoretically infinite different colors components.

In some embodiments, an optical platform and/or system of the present disclosure comprises a spectral/hyperspectral imaging device that can detect changes in environmentally sensitive fluorescent probes, such as, e.g., solvatochromic fluorophores, at a high resolution, such as, e.g., a pixel level. Environmentally sensitive fluorophores can probe physical and/or chemical properties through different photochemical mechanisms, including, e.g., changes of fluorescence quantum yield and/or changes in the emission color. In some embodiments, the environmentally sensitive fluorophores are chosen from solvatochromic fluorophores. Solvatochromic fluorophores are a class of nano-environment sensitive probes. Many solvatochromic fluorophores are commercially available. Furthermore, solvatochromic fluorophores can be chemically functionalized to carry out specific applications (e.g., organelle localization, chemo-selective reactivity, etc.). Examples of solvatochromic fluorophores include, but are not limited to, propionyl-2-(dimethylaminonaphthalene) (PRODAN); 6-acetyl-2-dimethylaminonaphthalene (ACDAN); nitrobenz-2-oxa-1,3-diazol-4yl amine (NBD); coumarin derivatives; oxazine derivatives, such as ); 9-(diethylamino)-5H-benzo[a]phenoxazin-5-one (Nile Red), [9-(diethylamino)benzo[a]phenoxazin-5-ylidene]azanium sulfate (Nile Blue); dimethylamino-phthalimide/naphthalimides; merocyanines; Daproxyl® derivatives; and 1-(2-maleimidylethyl)-4-(5-(4-methoxyphenyl)oxazol-2-yl) pyridinium methanesulfonate) (PyMPO). Some classes of solvatochromic fluorophores (e.g., ACDAN, Nile Red, etc.) are sensitive to the local environment thanks to a dipolar moment that is formed transiently at the excited state. The emission color and fluorescence lifetime depend on the magnitude of interaction between the dipole moment and the local environment (Dipolar Relaxation).

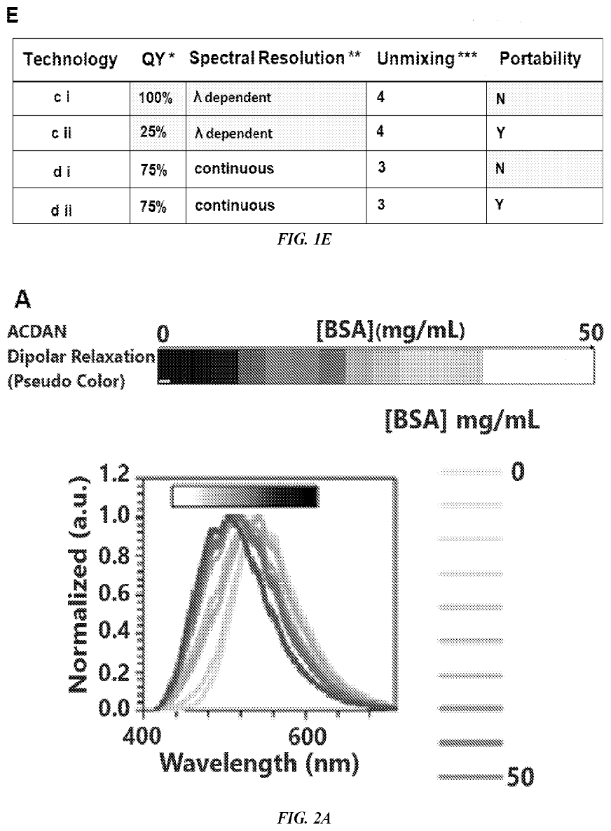

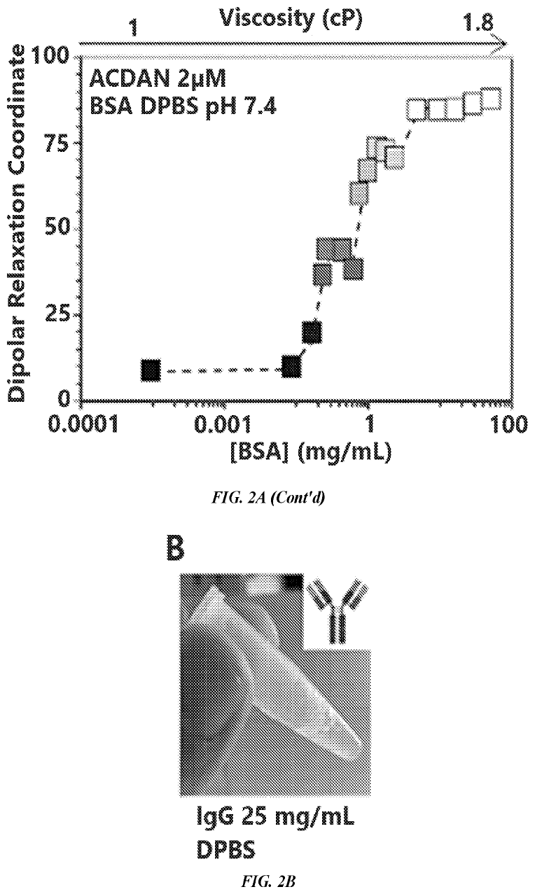

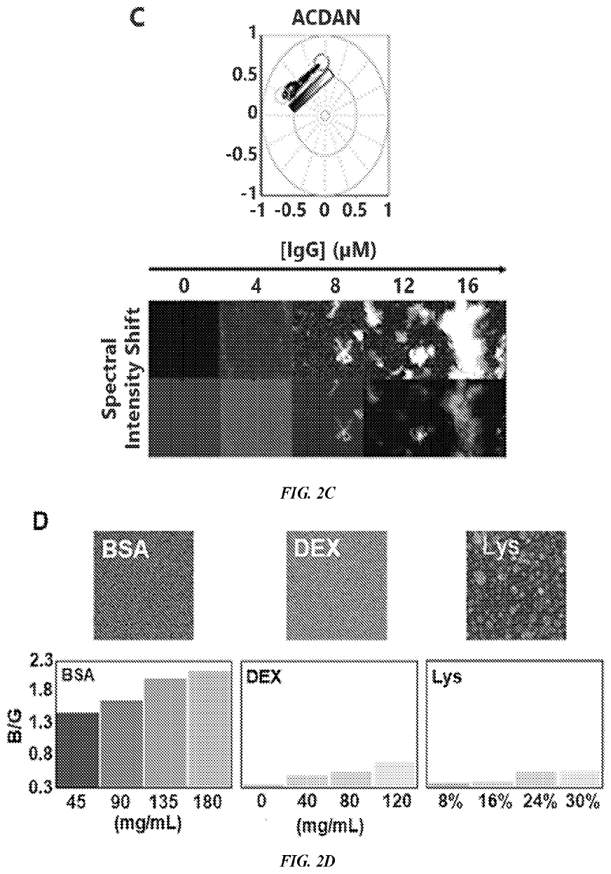

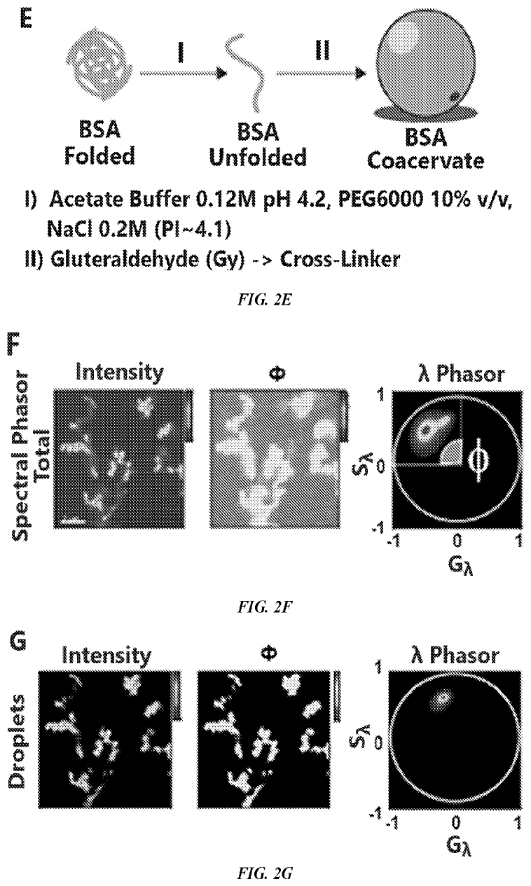

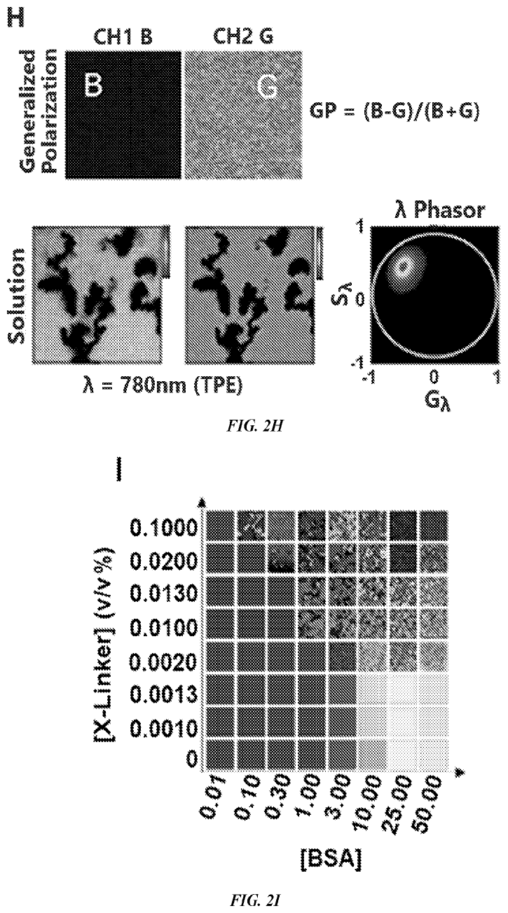

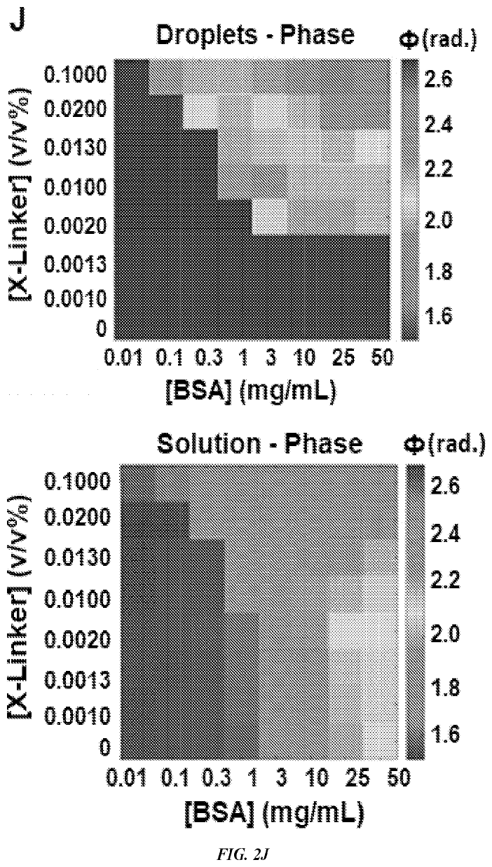

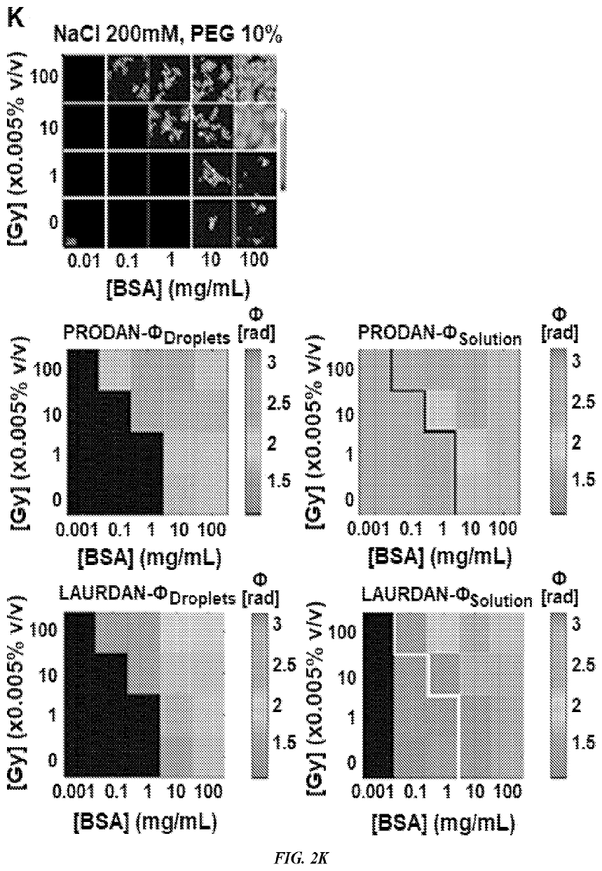

In some embodiments, the optical platform and/or system of the present disclosure utilizes multiparametric methods to characterize the environmentally sensitive fluorescent probes. Illustratively, the emission color of environmentally sensitive fluorescent probes can give information about protein concentration and protein oligomerization state (e.g., see FIG. 2A). For instance, ACDAN changes emission color from green (520/25 nm) to blue (450/25 nm) depending on the Bovine Serum Albumin (BSA) concentration. ACDAN appears to also be sensitive to BSA oligomerization since the dipolar relaxation coordinate revealed two inflection points at about 0.5 mg/mL and 1.5 mg/mL of BSA (e.g., see FIG. 2A). ACDAN is also sensitive to protein aggregation since, in the presence of a turbid solution of Immunoglobulin G (IgG), the probe revealed a completely different spectrum comparing the aggregated protein respect to the solution (e.g., see FIG. 2B-C). ACDAN color shift also depends on the viscosity of the sample. The ACDAN response depends on protein type, protein concentration, viscosity, and the presence of aggregated/other phases. ACDAN emission color shift depending on concentration of dextran (very viscous molecule) and depends on the presence of lysozyme aggregation. (e.g., see FIG. 2D-E).

In some embodiments, the optical platform and/or system of the present disclosure utilizes data analysis of spectral/hyperspectral images to better detect the presence of aggregates/phase separation using the spectral/hyperspectral imaging device disclosed herein. In some embodiments, the spectral/hyperspectral imaging device enables two different approaches for the measurements of the hyperspectral/spectral properties of the solvatochromic fluorophores and for the detection of particles of different colors: (i) spectral phasor analysis, and (ii) generalized polarization analysis (e.g., see FIG. 2F). The spectral phasor is a method that permits the representation of the spectrum of each pixel of the image in a coordinate phasor plot following the equations reported by Malacrida et. al. (“A multidimensional phasor approach reveals LAURDAN photophysics in NIH-3T3 cell membranes.” Sci Rep 7(1):9215 (2017)). The spectral phasor is a fast, unbiased, and user-friendly way to analyze complex spectral images data sets. The intensity ratio of two spectral bands is a simple and straightforward way to detect changes in the fluorescence emission spectrum. The image analysis allows segmentation of the regions of the images that are related to different features (such as, e.g., aggregates or phase separation behavior). This approach enables the measurement of the spectrum of a system composed of phase separated BSA with a cross-linker (e.g., see FIG. 2G). The combination of the data analysis with the capability of the solvatochromic probes of sensing differences in the polarity and viscosity of the environment permitted to assess the protein phase separation diagram. The BSA aggregates and the surrounding solutions shown different types of environments depending on the protein and cross-linker concentrations (e.g., see FIG. 2I-K).

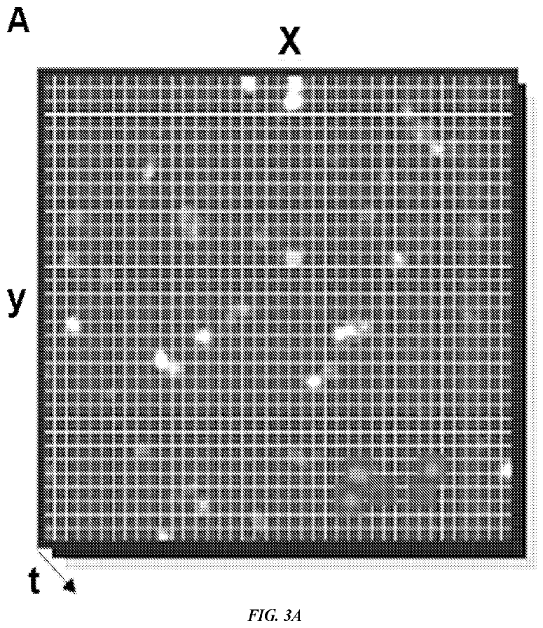

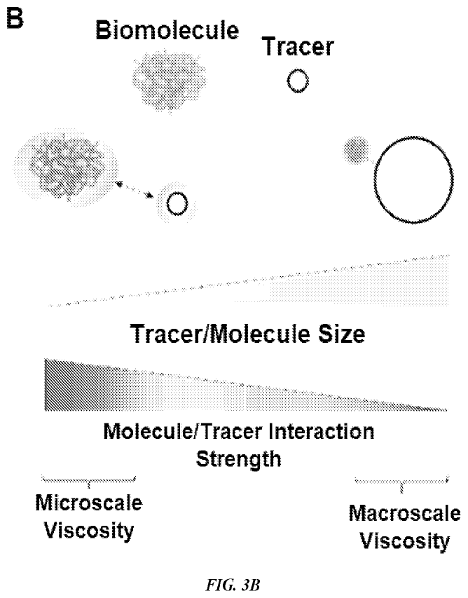

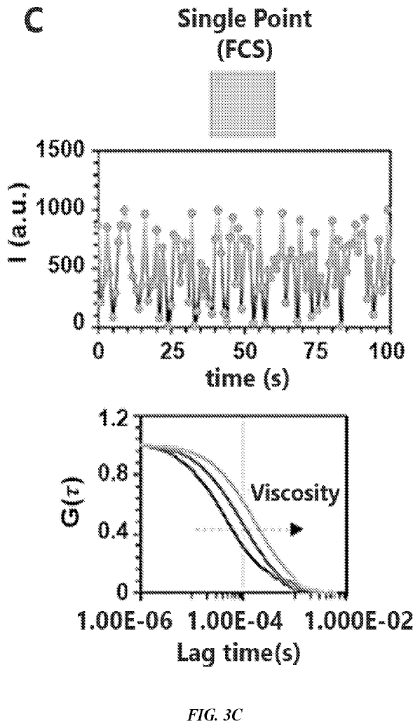

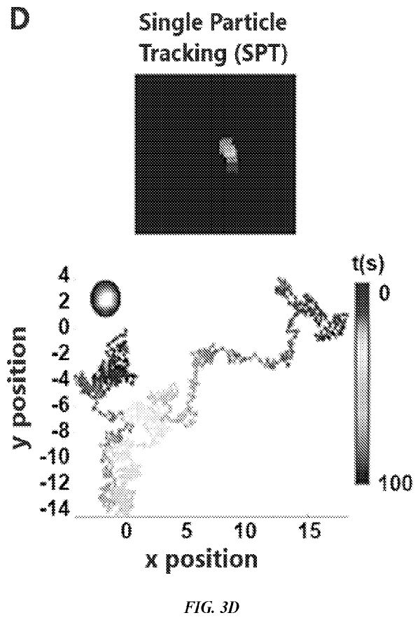

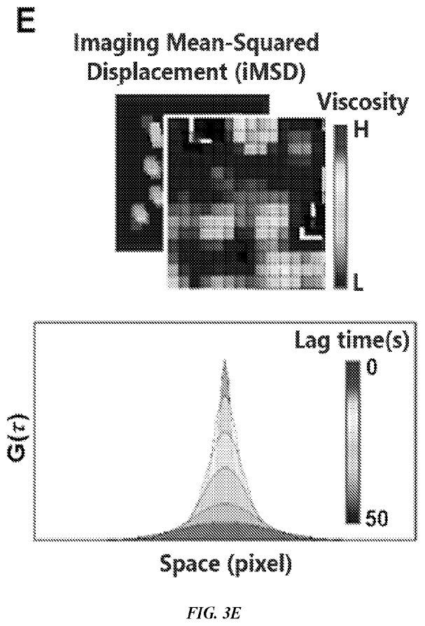

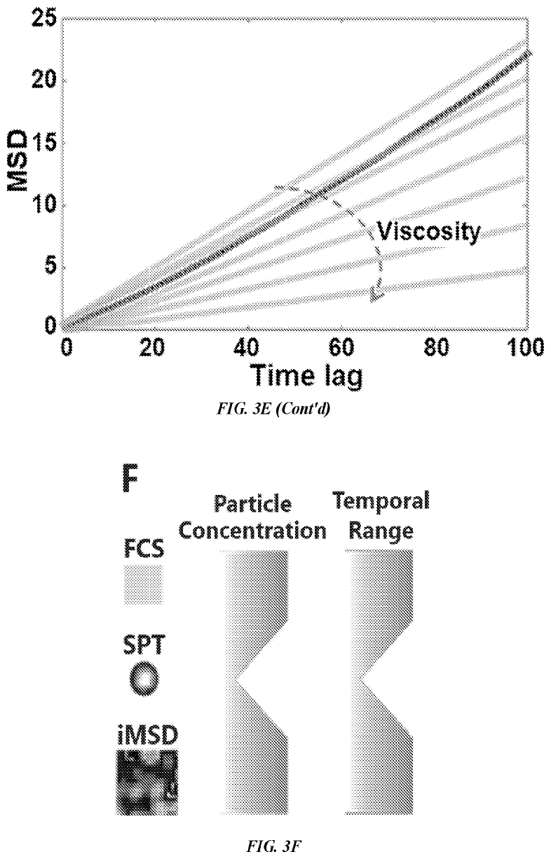

Fluorescence methods for the characterization of particle dynamics have facilitated the assessment of the physico-chemical properties of complex systems such as proteins and nucleic acids in vitro and in vivo. In some embodiments, the optical platform and/or system of the present disclosure utilizes very high spatiotemporal resolution fluorescence fluctuation analysis to measure viscosity and aggregation processes at nanoscale. A high-throughput optical platform or system of the present disclosure may comprise spectral/hyperspectral imaging devices that can detect particle dynamics, such as camera detection (e.g., see FIG. 3A). Camera detection permits three different approaches for the particle dynamics with the same data set: (i) Single Point Fluorescence Correlation (single point FCS), (ii) Single Particle Tracking (SPT), and (iii) imaging Mean Square Displacement (iMSD) (e.g., see FIG. 3C-E). These methods allow the assessment of viscosity by monitoring the diffusion coefficient of fluorescent tracers. These methods are based on three different data analysis and can give information on different spatiotemporal scale, and they can work with different tracer concentration (e.g., see FIG. 3F). Multicolor detection facilitates this approach because tracers of different size or surface properties assess the viscosity at two different regimes. When the tracer has a similar size to the crowder, the viscosity probed depends strongly on the tracer-crowder interaction (e.g., see FIG. 3B). If the tracer is bigger than the molecular crowder (e.g., at least 6 times bigger) the viscosity depends on the crowder-crowder interaction as determined using Shah et al., (“Micro- and macro-viscosity relations in high concentration antibody solutions.” European Journal of Pharmaceutics and Biopharmaceutics 153:211-221 (2020)). The accurate measurement of viscosity and molecule-molecule interactions requires flexibility on the tracer type. It is important that the tracer be capable of simultaneously assessing the dynamic of a different type of particle for increasing the throughput and for improving the sensitivity of the analysis. For these reasons, the design of the spectral/hyperspectral imaging device allows for the simultaneous assessment of multiple (e.g., up to three) different emission color tracers which can have different size or different surface properties.

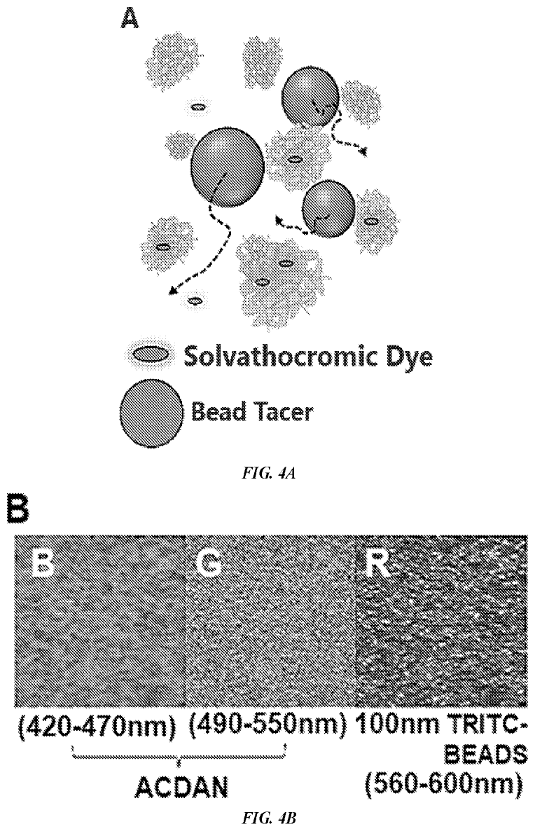

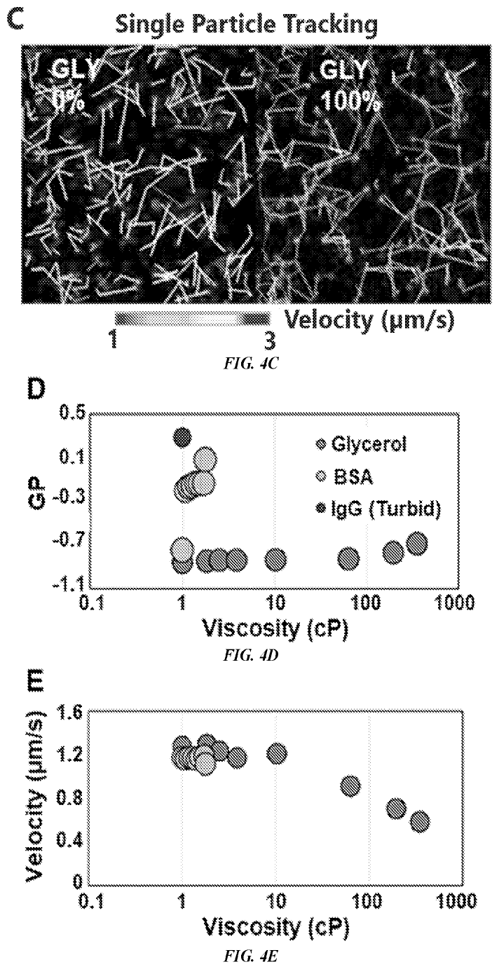

By strategically selecting the input particles (nano- and micro-beads, or different surface properties), particle concentrations, and nano-environment sensitive dyes, an optical system and/or platform of the present disclosure may assess the viscosity and one or more other physical and/or chemical properties of a sample (such as, e.g., aggregation or phase separation behavior) with very high throughput and sensitivity. A high-throughput optical platform and/or system of the present disclosure device allows for the simultaneous assessment of the spectral color changes of solvatochromic dyes together with particle dynamics. These observables are complementary and important for a better characterization of the physicochemical properties of the sample (e.g., see FIG. 4A-E). A high-throughput optical platform and/or system of the present disclosure is ideally suited for drug discovery and bioformulation where the nanoscale properties are important for the product quality. Fast screening of these properties is important for product development and for improving therapeutic efficacies. In addition to drug discovery and development, optical platforms and/or systems of the present disclosure can be used for product development in fields like immune therapy, solvents, glues, inks, liquid polymers, and cosmetics.

Kits and articles of manufacture are also described herein for use in a variety of high-throughput imaging applications. Such kits can comprise a carrier, package, or container that is compartmentalized to receive one or more containers such as vials, tubes, and the like, each of the container(s) comprising one of the separate elements to be used in the high throughput optical platform or system disclosed herein. Suitable containers include, for example, bottles, vials, syringes, and test tubes. The containers can be formed from a variety of materials such as glass or plastic.

For example, the container(s) can comprise one or environmentally sensitive fluorescent probes and/or fluorescent tracer particles described herein, optionally in a composition or in combination with another agent as disclosed herein. The container(s) optionally have a sterile access port (e.g., the container can be an intravenous solution bag or a vial having a stopper pierceable by a hypodermic injection needle). Such kits optionally comprise an identifying description or label or instructions relating to its use in the methods described herein.

A kit will typically comprise one or more additional containers, each with one or more of various materials (such as, e.g., reagents, probes, tracers) and/or devices (e.g., spectral/hyperspectral imaging devices) desirable from a commercial and user standpoint for use with high throughput optical platform or system disclosed herein described herein. The additional containers may further comprise labels listing contents and/or instructions for use, and package inserts with instructions for use of a spectral/hyperspectral imaging device disclosed herein. A kit may further comprise software that is configured to carry out the various methods disclosed herein, and/or control operation of a spectral/hyperspectral imaging device disclosed herein. A set of instructions will also typically be included.

A label can be on or associated with the container. A label can be on a container when letters, numbers or other characters forming the label are attached, molded, or etched into the container itself, a label can be associated with a container when it is present within a receptacle or carrier that also holds the container, e.g., as a package insert. A label can be used to indicate that the contents are to be used for a specific application. The label can also indicate directions for use of the contents, such as in the methods described herein.

The disclosure further provides that the devices, platforms, systems, devices and methods described herein can be further defined by the following aspects (aspects 1 to 48):
1. An optical system or platform that is configured to simultaneously assess viscosity and at least one additional physical and/or chemical property of a sample, comprising:
a hyperspectral/spectral imaging device that is configured to simultaneously detect and/or assess one or more spectral properties of one or more environmentally sensitive fluorophore(s) and to track the dynamics of one or more fluorescent tracker particle(s), wherein:
   tracking the dynamics of the one or more fluorescent tracker particle(s) can be used to assess the viscosity of the sample; and
   detecting and/or assessing the one or more spectral properties of the one or more environmentally sensitive fluorophore(s) can be used to assess the at least one additional physical and/or chemical property of the sample.
2. The optical system or platform of aspect 1, wherein the optical platform or system is capable of, or configured to, simultaneously assessing multiple samples, particularly, 2, 3, 4, 5, 6, 7, 8, 9, 10, 15, 20, 25, 30, 40, 50, 60, 70, 80, 90, 96, 100, 120, 140, 160, 180, 200, 250, 300, 350, 384, 400, 450, 500, 600, 700, 800, 900, 1000, 1100, 1200, 1300, 1400, 1500, 1536, 1600, 1700, 1800, 1900, 2000 or more samples, including a range of samples that includes or is between any two of the foregoing numbers of samples, more particularly, the optical platform or system is capable of, or configured to simultaneously assess 96, 384, or 1536 samples.
3. The optical system or platform of aspect 1 or aspect 2, wherein the at least one additional physical and/or chemical property of the sample is chosen from aggregation, phase separation behavior, pH, temperature, ionic potential, ionic strength, and kinetics over time.
4. The optical system or platform of aspect 3, wherein the at least one additional physical and/or chemical property of the sample is aggregation.
5. The optical system or platform of aspect 3, wherein the at least one additional physical and/or chemical property of the sample is phase separation behavior.
6. The optical system or platform of any one of the proceeding aspects, wherein the optical system or platform is capable of, or configured to, assess viscosity and at least one additional physical and/or chemical property (e.g., aggregation, phase separation behavior, pH, temperature, ionic potential, ionic strength, and kinetics over time) of a sample in less than 20, 19, 18, 17, 16, 15, 14, 13, 12, 11, 10, 9, 8, 7, 6, 5, 4, 3, or 2 seconds, particularly less than 10 seconds.
7. The optical system or platform of any one of the proceeding aspects, wherein each sample assessed has a volume independently chosen from 0.2 μL, 0.3 μL, 0.4 μL, 0.5 μL, 0.6 μL, 0.7 μL, 0.8 μL, 0.9 μL, 1.0 μL, 1.1 μL, 1.2 μL, 1.3 μL, 1.4 μL, 1.5 μL, 1.6 μL, 1.7 μL, 1.8 μL, 1.9 μL, 2.0 μL, 2.1 μL, 2.2 μL, 2.3 μL, 2.4 μL, 2.5 μL, 2.6 μL, 2.7 μL, 2.8 μL, 2.9 μL, 3.0 μL, 3.1 μL, 3.2 μL, 3.3 μL, 3.4 μL, 3.5 μL, 3.6 μL, 3.7 μL, 3.8 μL, 3.9 μL, 4.0 μL, 4.1 μL, 4.2 μL, 4.3 μL, 4.4 μL, 4.5 μL, 4.6 μL, 4.7 μL, 4.8 μL, 4.9 μL, 5.0 μL, 5.2 μL, 5.4 μL, 5.6 μL, 5.8 μL, 6.0 μL, 6.2 μL, 6.4 μL, 6.6 μL, 6.8 μL, 7.0 μL, 7.2 μL, 7.4 μL, 7.6 μL, 7.8 μL, 8.0 μL, 8.2 μL, 8.4 μL, 8.6 μL, 8.8 μL, 9.0 μL, 9.2 μL, 9.4 μL, 9.6 μL, 9.8 μL, 10.0 μL, 10.5 μL, 11.0 μL, 11.5 μL, 12.0 μL, 12.5 μL, 30.0 μL, 13.5 μL, 14.0 μL, 14.5 μL, 15.0 μL, 15.5 μL, 16.0 μL, 16.5 μL, 17.0 μL, 17.5 μL, 18.0 μL, 18.5 μL, 19.0 μL, 19.5 μL, 20.0 μL, 25.0 μL, 30.0 μL, 35.0 μL, 40.0 μL, 45.0 μL, 50.0 μL, 60.0 μL, 70.0 μL, 80.0 μL, 80.0 μL, 100.0 μL, and a range that includes or is between any two of the foregoing volumes, particularly, wherein each sample assessed has a volume independently chosen from 0.2 μL to 100.0 μL, inclusive of the endpoints.
8. The optical system or platform of any one of the proceeding aspects, wherein each sample assessed has a volume of 1.0 μL to 5.0 μL, inclusive of the endpoints.
9 The optical system or platform of any one of the proceeding aspects, wherein each sample assessed comprises one or more agent(s) chosen from molecules, biomolecules, compounds, and polymers.
10. The optical system or platform of aspect 9, wherein the one or more agent(s) are biomolecules chosen from proteins, peptides, lipids, saccharides, carbohydrates, nucleic acids, and steroids.
11. The optical system or platform of any one of the proceeding aspects, wherein the hyperspectral/spectral imaging device is a camera-based device, particularly, wherein the camera-based device is a red, green, blue (RGB) camera.
12. The optical system or platform of any one of the proceeding aspects, wherein the optical system or platform further comprises a wide field microscopy setup, a high and low illumination (HiLo) setup, or a structured illumination microscopy (SIM) setup.
13. The optical system or platform of any one of the proceeding aspects, wherein the hyperspectral/spectral imaging device performs multicolor detection.
14. The optical system or platform of aspect 13, wherein the hyperspectral/spectral imaging device is capable of, or configured to, assess 2, 3, or 4 different color components in a single pixel simultaneously, particularly, 3 different color components in a single pixel simultaneously.
15. The optical system of any one of the proceeding aspects, wherein the hyperspectral/spectral imaging device achieves spectral/hyperspectral detection using a modality chosen from band-pass filters, band-pass camera masks, sin/cosine filters, and sin/cosine camera masking.
16. The optical system or platform of any one of the proceeding aspects, wherein the hyperspectral/spectral imaging device utilizes a plurality of spectral and/or hyperspectral detection modalities that differ by efficiencies in terms of one or more properties chosen from quantum yield, spectral resolution, single pixel sensitivity, and portability.
17. The optical system or platform of aspect 16, wherein the plurality of spectral and/or hyperspectral detection modalities comprise band-pass filters, band-pass camera masks, sin/cosine filters, and/or sin/cosine camera masking, particularly wherein the plurality of spectral and/or hyperspectral detection modalities comprise band-pass filters.
18. The optical system or platform of any one of the proceeding aspects, wherein the optical system or platform comprises one or more environmentally sensitive fluorophore probe(s) that can probe the presence of aggregates and/or phase separation in the sample based on a change of fluorescence quantum yield and/or a change in emission color.
19. The optical system or platform of aspect 18, wherein at least one of the one or more environmentally sensitive fluorophore probe(s) is capable of providing nanometer scale sensitivity.
20. The optical system or platform of aspect 18 or aspect 19, wherein at least one of the one or more environmentally sensitive fluorophore probe(s) is independently chosen from solvatochromic fluorophore-based probes.
21. The optical system or platform of any one of aspects 18 to 20, wherein at least one of the one or more environmentally sensitive fluorophore probe(s) is independently chosen from propionyl-2-(dimethylaminonaphthalene) (PRODAN), 6-acetyl-2-dimethylaminonaphthalene (ACDAN), nitrobenz-2-oxa-1,3-diazol-4yl amine (NBD), coumarin derivatives, oxazine derivatives, 9-(diethylamino)-5H-benzo[a]phenoxazin-5-one (Nile Red), [9-(diethylamino)benzo[a]phenoxazin-5-ylidene]azanium sulfate (Nile Blue), dimethylamino-phthalimide/naphthalimides, merocyanines, and 1-(2-maleimidylethyl)-4-(5-(4-methoxyphenyl)oxazol-2-yl) pyridinium methanesulfonate) (PyMPO).
22. The optical system or platform of any one of aspects 18 to 21, wherein at least one of the one or more environmentally sensitive fluorophore probe(s) is independently chosen from ACDAN and Nile Red.
23. The optical system or platform of any one of aspects 18 to 22, wherein the spectral/hyperspectral imaging device is capable of, or configured to, detect changes in at least one of the one or more environmentally sensitive probe(s) caused by the presence of aggregate and/or phase separation in the sample by using spectral phasor analysis and/or generalized polarization analysis.
24. The optical system or platform of aspect 23, wherein the optical system or platform is capable of, or configured to, use phasor analysis to segment regions of images that are related to different features, wherein the different features correspond to aggregates and/or phase separations.
25. The optical system or platform of any one of the proceeding aspects, wherein the optical system or platform comprises a plurality of fluorescently labeled tracker particles, wherein the spectral/hyperspectral imaging device is capable of, or configured to, track the dynamics of the plurality of fluorescently labeled tracker particles.
26. The optical system or platform of aspect 25, wherein the viscosity of each sample assessed can be determined based upon the dynamics of the plurality of fluorescently labeled tracker particles.
27. The optical system or platform of aspect 25 or aspect 26, wherein the plurality of fluorescently labeled tracker particles comprises particles of different sizes and/or surface properties that emit different color tracers.
28. The optical system or platform of any one of aspects 25 to 27, wherein the spectral/hyperspectral imaging device is capable of, or configured to, record one or more fluorescence fluctuations of the plurality of fluorescently labeled tracker particles over time and measuring an autocorrelation function to obtain a diffusion coefficient of the plurality of fluorescently labeled tracker particles that is inversely proportional to the viscosity of each sample assessed.
29. The optical system or platform of any one of aspects 25 to 28, wherein the spectral/hyperspectral imaging device is configured to detect the position of each fluorescently labeled tracker particle over time, and further wherein the viscosity of each sample is assessed based upon changes and/or dynamics in the position of the fluorescently labeled tracker particles.
30. The optical system or platform of any one of aspects 25 to 29, wherein the dynamics of the plurality of fluorescently labeled tracker particles is mapped by imaging mean square displacement (iMSD) with a pixel averaged spatiotemporal correlation function which decays and spreads as function of the lag time, and wherein the decays depend on the particle dynamics that is influenced by the viscosity of the sample.
31. The optical system or platform of any one of the preceding aspects, wherein the hyperspectral/spectral imaging device comprises:
a light emitting device that emits a beam of light;
one or more mirrors that direct the beam of light from the light emitting device to a light filter;
a light filter that filters the light emitted from the light emitting device to have a certain frequency so as to generate fluorescence signals from the one or more environmentally sensitive fluorophore(s) and one or more fluorescent tracker particle(s) in the sample, and directs the fluorescence signals generated from the one or more environmentally sensitive fluorophore(s) and one or more fluorescent tracker particle(s) in the sample to a camera detector;
one or more signal processing filters that filter the fluorescence signals prior to detection by the camera detector;
a camera detector that acquires a plurality of images over time of the filtered fluorescence signals generated from the one or more environmentally sensitive fluorophore(s) and one or more fluorescent tracker particle(s) in the sample; and
an analyzing device that assesses the spectral properties of the one or more environmentally sensitive fluorophore(s) and one or more fluorescent tracker particle(s) from the plurality of images generated from the camera detector.
32. The optical system or platform of aspect 31, wherein the light emitting device that emits a beam of light is a laser or a light emitting diode.
33. The optical system or platform of aspect 31 or aspect 32, wherein the light emitting device emits a beam of light in the visible spectrum.
34. The optical system or platform of any one of aspects 31 to 33, wherein the light emitting device emits a beam of light having a wavelength of 380 nm, 385 nm, 390 nm, 395 nm, 400 nm, 405 nm, 410 nm, 415 nm, 420 nm, 425 nm, 430 nm, 435 nm, 440 nm, 445 nm, 450 nm, 455 nm, 460 nm, 465 nm, 470 nm, 475 nm, 480 nm, 485 nm, 490 nm, 495 nm, 500 nm, 505 nm, 510 nm, 515 nm, 520 nm, 525 nm, 530 nm, 535 nm, 540 nm, 545 nm, 550 nm, 555 nm, 560 nm, 565 nm, 570 nm, 575 nm, 580 nm, 585 nm, 590 nm, 595 nm, 600 nm, 605 nm, 610 nm, 615 nm, 620 nm, 625 nm, 630 nm, 635 nm, 640 nm, 645 nm, 650 nm, 655 nm, 660 nm, 665 nm, 670 nm, 675 nm, 680 nm, 685 nm, 690 nm, 695 nm, 700 nm, 705 nm, 710 nm, 715 nm, 720 nm, 725 nm, 730 nm, 735 nm, to 740 nm, or a range of wavelengths that includes or is between any two of the foregoing wavelengths (e.g., from 380 nm to 600 nm), including fractional increments thereof, particularly, wherein the light emitting device emits a beam of light having a wavelength in the range of from 380 nm to 600 nm, more particularly, wherein the light emitting device emits a beam of light having a wavelength of 405 nm.
35. The optical system or platform of any one of aspects 31 to 34, wherein the one or more mirrors are orientated to reflect light at an angle of 25°, 30°, 35°, 40°, 45°, 50°, 55°, 60°, 65°, 70°, 75° or a range of wavelengths that includes or is between any two of the foregoing angles of reflection, including fractional increments thereof, particularly, wherein the one or more mirrors are orientated to reflect light at an angle from 30° to 60°.
36. The optical system or platform of aspect 35, wherein the one or more mirrors are orientated to reflect light at an angle of 45°.
37. The optical system or platform of any one of aspects 31 to 36, wherein the light filter is a dichroic filter.
38. The optical system or platform of any one of aspects 31 to 37, wherein the one or more signal processing filters are selected from band pass filters, short pass filters, long pass filters, and multi-band pass filters.
39. The optical system or platform of any one of aspects 31 to 38, wherein the camera detector is a red, green, blue (RGB) camera.
40. The optical system or platform of any one of aspects 31 to 39, wherein the analyzing device is a smart phone, computer, or tablet.
41. A method for simultaneously assessing viscosity and at least one additional physical and/or chemical property of a sample, comprising:
introducing one or more fluorescently labeled tracker particle(s) and one or more environmentally sensitive fluorophore probe(s) into the sample; and
using the optical system or platform of any one of aspects 1 to 40 to assess the viscosity and the at least one additional physical and/or chemical property of the sample.
42. The method of aspect 41, wherein the sample is a sample for drug discovery, a bioformulation sample, an immune therapy sample, a solvent sample, a glue sample, an ink sample, a liquid polymer sample, or a cosmetic sample.
43. The method of aspect 41 or aspect 42, wherein the at least one additional physical and/or chemical property of the sample is chosen from aggregation, phase separation behavior, pH, temperature, ionic potential, ionic strength, and kinetics over time.
44. The method of aspect 43, wherein the at least one additional physical and/or chemical property of the sample is aggregation.
45. The method of aspect 43, wherein the at least one additional physical and/or chemical property of the sample is phase separation behavior.
46. The method of any one of aspects 41 to 45, wherein the sample has a volume selected from 0.2 μL to 100.0 μL, inclusive of the endpoints.
47. The method of any one of aspects 41 to 46, wherein the one or more environmentally sensitive fluorophore probe(s) are independently chosen from propionyl-2-(dimethylaminonaphthalene) (PRODAN), 6-acetyl-2-dimethylaminonaphthalene (ACDAN), nitrobenz-2-oxa-1,3-diazol-4yl amine (NBD), coumarin derivatives, oxazine derivatives, 9-(diethylamino)-5H-benzo[a]phenoxazin-5-one (Nile Red), [9-(diethylamino)benzo[a]phenoxazin-5-ylidene]azanium sulfate (Nile Blue), dimethylamino-phthalimide/naphthalimides, merocyanines, and 1-(2-maleimidylethyl)-4-(5-(4-methoxyphenyl)oxazol-2-yl) pyridinium methanesulfonate) (PyMPO).
48. The method of aspect 47, wherein the one or more environmentally sensitive fluorophore probe(s) are independently chosen from ACDAN and Nile Red.

### EXAMPLES

In order that the present disclosure may be more fully understood, the following examples are set forth. It should be understood that these examples are for illustrative purposes only and are not to be construed as limiting this disclosure in any manner.

### Example 1. General Protocol

A general protocol for the assessment of biomolecule aggregation consists of measuring the optical properties of a solvatochromic dye in the presence of biomolecule sample. A dye stock solution of 1-50 mM solution of solvatochromic dye (e.g., in water, DMSO, acetonitrile, ethanol, methanol, any water-soluble solvent, or suitable combinations thereof) is prepared in a plastic tube. Once the dye is solubilized/dispersed in the solvent, it can be used for the assay. A small volume of the dye stock solution is dispersed into a tube containing a solution comprising a biomolecule to a final dye concentration of 0.1-6 μM. The tube is mixed gently using a vortex. The sample is then placed on an optical grade well 1.5 bottomed glass and placed on the microscope sample holder. The microscope is set to maximize the signal-to-noise ratio, adjusting excitation light intensity (wavelength and power) and detector dwell time. In a typical setting, each image is acquired integrating the signal up to 20 s for a whole frame.

### Materials

Materials are used as received the suppliers: Bovine Serum Albumin (BSA, >96%, ˜66 kDa, Lot #SLBG1645V, Sigma, USA), Acetic Acid (Glacial, Sigma, USA), Polyethylene Glycol 8000 (PEG8000, 40 % (w/w) in H₂O, 8,000 Da, Sigma), Sodium Chloride (NaCl, 99%, 58.44 g/mol, Sigma, USA), Glutaraldehyde (GY, Grade I, 25% in H₂O, 100.12 g/mol, Sigma, USA), Dulbecco's Phosphate Buffer Saline (PBS, pH 7.4, Thermo Fisher Scientific, USA), Cellulose Dialysis Membrane (12-14 kDa cut off, Sigma, USA). 6-acetyl-2-dimethylaminonaphthalene (ACDAN, >98%, 213.28 g/mol, Toronto Research Chemicals, Toronto, ON, Canada).

### Data Analysis

Generalized polarization analysis (GP) is defined as the subtraction divided the sum of two different spectral bands emission of the solvatochromic dyes. For ACDAN/PRODAN/LAURDAN, the blue band typically ranges from 420 to 475 nm and the green band ranges from 490 to 530 nm.

### Phasor Analysis

FLIM images are segmented in background and droplets by using a 2-component Gaussian Mixture Model (GMM) clustering applied to the hyperspectral phasor distributions. The sum of the spectral signature from those regions is transformed into angular phasor coordinates (Φ). The images are successively false colored with the phase values, indicating the different optical properties of the solvatochromic dye staining the aggregates or in solution.

### Example 2. ACDAN Shift in the Presence of BSA

The spectral shift of the solvatochromic probe 6-acetyl-2-dimethylaminonaphthalene (ACDAN, >98%, 213.28 g/mol, Toronto Research Chemicals, Toronto, ON, Canada) in the presence of several amounts of Bovine Serum Albumin (BSA, >96%, ˜66 kDa, Sigma, USA) was investigated (FIG. 2A), adapting a previously reported procedure. Specifically, a 31.3 mM stock solution of ACDAN in Dimethyl Sulfoxide (DMSO, anhydrous, ≥99.9%, 78.13 g/mol, Sigma, USA) was prepared, weighing on a precision scale 8.5 mg of ACDAN. The ACDAN was then dissolved in 1 mL DMSO in a 2 mL plastic tube. A BSA solution was prepared by weighing on a precision scale 1000 mg of BSA, which was then placed in a 50 mL Falcon tube. 10 mL of Dulbecco's modified Phosphate Buffer Saline (PBS, pH 7.4, Thermo Fisher Scientific, USA) are placed was added to the Falcon tube. The BSA was allowed to dissolve overnight at 4° C. until the solution was clear and no large aggregates were observed.

The assay was carried out by diluting 100 mg/mL BSA stock solution with PBS in a plastic tube to a final protein concentration ranging from 0.01 mg/mL to 50 mg/mL. 100 μL of protein solution was placed in a 500 μL plastic tube and ACDAN solution was added to a final concentration of 2 μM. The samples were then loaded on 18 bottomed glass wells (Ibidi, Germany) and placed on the microscope sample holder. Images were acquired with a fluorescence confocal laser microscope ZEISS LSM 880 equipped with the hyperspectral 32 channels detector. For each solution, an image was taken (acquisition time: 40 s, laser excitation set at 405 nm using a 60×1.4 NA oil immersion objective). The hyperspectral images were then analyzed with SimFCS (LFD, University of California, Irvine) using the pipeline called phasor transformation (Citation: Torrado, B.; Malacrida, L.; Ranjit, S. Linear Combination Properties of the Phasor Space in Fluorescence Imaging. Sensors 2022, 22, 999. .org/10.3390/s22030999).

### Example 3. ACDAN Shift in the Presence of IgG

FIGS. 2B and 2C show evaluation of ACDAN behavior in the presence of an immunoglobulin G (IgG) dispersion. Specifically, 22.25 mg of Immunoglobulin G (IgG, ≥95%, Sigma, USA) was weighed on a scale and placed in a 2 mL plastic tube. 500 μL of Dulbecco's Phosphate Buffer Saline (PBS, pH 7.4, Thermo Fisher Scientific, USA) was added to a final concentration of 45 mg/mL. The dispersion formed was then dissolved with PBS to a final concentration ranging from 4 to 16 mg/mL. ACDAN staining was carried out by adding a few microliters of ACDAN DMSO solution to a final concentration of 5 μM. For the assessment of aggregates using hyperspectral fluorescence microscopy imaging, the protein stock solution was used following a similar procedure to those described in Examples 1 and 2.

### Example 4. ACDAN Staining for BSA, Dextran, and Lysozyme

BSA, Dextran, and Lysozyme were examined using ACDAN (FIG. 2D). A 180 mg/mL solution of Bovine Serum Albumin (BSA, >96%, ˜66 kDa, Sigma, USA) was prepared by dispersing 1.8 g of BSA in 10 mL of Dulbecco's modified Phosphate Buffer Saline (PBS, pH 7.4, Thermo Fisher Scientific, USA) in a 50 mL Falcon tube. The Falcon tube was placed in the fridge for about 24 hours until macroscopic aggregates were not observed. Several concentrations (45-180 mg/mL) were stained with 5 μM of ACDAN and imaged according to a protocol similar to those described above. A 120 mg/mL stock solution of Dextran (Dextran, ˜450,000-650,000 Da, Sigma USA) was prepared by dissolving 240 mg of Dextran in 2 mL of PBS. Several concentrations (40-120 mg/mL) were stained with 5 μM of ACDAN and imaged according to a protocol similar to those described above. A 350 mg/mL stock solution of Lysozyme (Lysozyme from chicken egg white, lyophilized powder, protein ≥90 %, ≥40,000 units/mg protein, ˜14.3 kDa, Sigma USA) was prepared by dispersing 350 mg of protein in 1 mL of acetate buffer 0.1 M pH 4.2 and 50 mM of Sodium Chloride. Several concentrations were probed with 5 μM of ACDAN.

### Example 5. Assessing BSA Coacervates

The properties of BSA coacervates were examined using an imaging system described herein (FIGS. 2E-2K). A freshly prepared 130-170 mg/mL BSA solution in PBS was dialyzed against MilliQ water extensively for 24 hours with a 12 MWCO cellulose dialysis membrane. After the dialysis, the BSA concentration was about 100-150 mg/mL (concentration monitored after the dialysis with UV-vis with absorption spectrum, at 280 nm, Nano-Drop). Then a prespecified amount of BSA was dissolved in a 500 μL-tube with 100 μL of Acetic/Acetate buffer 0.2 M pH 4.2 with 10-20% v./v. of PEG 8000 and 200 mM of NaCl, with MilliQ water added to achieve a final volume of 200 μL. The final concentration of BSA ranged from 0.001 mg/mL to 100 mg/mL, and the final buffer concentration was 0.1M Acetic acid/acetate and 5-10% v. of PEG8000. The solutions were immediately placed in an eight-well imaging dish. To crosslink the BSA coacervates, several amounts of GY (from 0% to 2.54% wt) were added directly inside the imaging chambers. After 24 hours, the coacervates were placed on the sample holder and imaged with a microscope. Solvatochromic staining through the addition of ˜0.2-3 μL of a DMSO solution comprising solvatochromic dye (5 μM final ACDAN/PRODAN/LAURDAN concentration) was carried out 3 hours before imaging.

The disclosed subject matter is not intended to be limited in scope by the specific embodiments described herein, which are instead intended as non-limiting illustrations of individual aspects of the disclosure. Functionally equivalent methods and components are within the scope of the disclosure. Indeed, various modifications of the disclosed subject matter, in addition to those shown and described herein, will be apparent to those skilled in the art from the foregoing description and accompanying drawing(s). Such modifications are intended to fall within the scope of the disclosed subject matter.

The descriptions of the various embodiments and/or examples of the disclosed subject matter have been presented for purposes of illustration but are not intended to be exhaustive or limiting in any way. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, and/or to enable others of ordinary skill in the art to understand the disclosed subject matter.

1. An optical system or platform that is configured to simultaneously assess viscosity and at least one additional physical and/or chemical property of a sample, comprising:
a hyperspectral/spectral imaging device that is configured to simultaneously detect and/or assess one or more spectral properties of one or more environmentally sensitive fluorophore(s) and to track the dynamics of one or more fluorescent tracker particle(s), wherein:
tracking the dynamics of the one or more fluorescent tracker particle(s) can be used to assess the viscosity of the sample; and
detecting and/or assessing the one or more spectral properties of the one or more environmentally sensitive fluorophore(s) can be used to assess the at least one additional physical and/or chemical property of the sample.

2. (canceled)

3. The optical system or platform of claim 1, wherein the at least one additional physical and/or chemical property of the sample is chosen from aggregation, phase separation behavior, pH, temperature, ionic potential, ionic strength, and kinetics over time.

4-10. (canceled)

11. The optical system or platform of claim 1, wherein the hyperspectral/spectral imaging device is a camera-based device.

12. The optical system or platform of claim 1, wherein the optical system or platform further comprises a wide field microscopy setup, a high and low illumination (HiLo) setup, or a structured illumination microscopy (SIM) setup.

13. The optical system or platform of claim 1, wherein the hyperspectral/spectral imaging device performs multicolor detection.

14. (canceled)

15. The optical system or platform of claim 1, wherein the hyperspectral/spectral imaging device achieves spectral/hyperspectral detection using a modality chosen from band-pass filters, band-pass camera masks, sin/cosine filters, and sin/cosine camera masking.

16-17. (canceled)

18. The optical system or platform of claim 1, wherein the optical system or platform comprises one or more environmentally sensitive fluorophore probe(s) that can probe the presence of aggregates and/or phase separation in the sample based on a change of fluorescence quantum yield and/or a change in emission color.

19. (canceled)

20. The optical system or platform of claim 18, wherein at least one of the one or more environmentally sensitive fluorophore probe(s) is independently chosen from solvatochromic fluorophore-based probes.

21-22. (canceled)

23. The optical system or platform of claim 18, wherein the spectral/hyperspectral imaging device is capable of detecting changes in at least one of the one or more environmentally sensitive probe(s) caused by the presence of aggregate and/or phase separation in the sample by using spectral phasor analysis and/or generalized polarization analysis.

24. (canceled)

25. The optical system or platform of claim 1, wherein the optical system or platform comprises a plurality of fluorescently labeled tracker particles, wherein the spectral/hyperspectral imaging device is configured to track the dynamics of the plurality of fluorescently labeled tracker particles.

26. (canceled)

27. The optical system or platform of claim 25, wherein the plurality of fluorescently labeled tracker particles comprises particles of different sizes and/or surface properties that emit different color tracers.

28. The optical system or platform of claim 25, wherein the spectral/hyperspectral imaging device is configured to record one or more fluorescence fluctuations of the plurality of fluorescently labeled tracker particles over time and measuring an autocorrelation function to obtain a diffusion coefficient of the plurality of fluorescently labeled tracker particles that is inversely proportional to the viscosity of each sample assessed.

29-30. (canceled)

31. The optical system or platform of claim 1, wherein the hyperspectral/spectral imaging device comprises:
a light emitting device that emits a beam of light;
one or more mirrors that direct the beam of light from the light emitting device to a light filter;
a light filter that filters the light emitted from the light emitting device to have a certain frequency so as to generate fluorescence signals from the one or more environmentally sensitive fluorophore(s) and one or more fluorescent tracker particle(s) in the sample, and directs the fluorescence signals generated from the one or more environmentally sensitive fluorophore(s) and one or more fluorescent tracker particle(s) in the sample to a camera detector;
one or more signal processing filters that filter the fluorescence signals prior to detection by the camera detector;
a camera detector that acquires a plurality of images over time of the filtered fluorescence signals generated from the one or more environmentally sensitive fluorophore(s) and one or more fluorescent tracker particle(s) in the sample; and
an analyzing device that assesses the spectral properties of the one or more environmentally sensitive fluorophore(s) and one or more fluorescent tracker particle(s) from the plurality of images generated from the camera detector.

32-33. (canceled)

34. The optical system or platform of claim 31, wherein the light emitting device emits a beam of light having a wavelength in the range of from 380 nm to 600 nm.

35-36. (canceled)

37. The optical system or platform of claim 31, wherein the light filter is a dichroic filter.

38. The optical system or platform of claim 31, wherein the one or more signal processing filters are selected from band pass filters, short pass filters, long pass filters, and multi-band pass filters.

39. The optical system or platform of claim 31, wherein the camera detector is a red, green, blue (RGB) camera.

40. The optical system or platform of claim 31, wherein the analyzing device is a smart phone, computer, or tablet.

41. A method for simultaneously assessing viscosity and at least one additional physical and/or chemical property of a sample, comprising:
introducing one or more fluorescently labeled tracker particle(s) and one or more environmentally sensitive fluorophore probe(s) into the sample; and
using the optical system or platform of claim 1 to assess the viscosity and the at least one additional physical and/or chemical property of the sample.

42. (canceled)

43. The method of claim 41, wherein the at least one additional physical and/or chemical property of the sample is chosen from aggregation, phase separation behavior, pH, temperature, ionic potential, ionic strength, and kinetics over time.

44-48. (canceled)
